(19) United States
(12) Patent Application Publication
(10) Pub. No.: US 2026/0213470 A1
(43) Pub. Date: Jul. 23, 2026

(54) ELECTRICAL CONNECTOR, COMMUNICATION NETWORK AND METHOD FOR OPERATING AN ELECTRICAL CONNECTOR

(71) Applicant: ELMOS Semiconductor SE, Leverkusen (DE)

(72) Inventors: Ralf Abel, Altkrautheim (DE); Thomas Rotter, Neunkirchen am Brand (DE); Julia Koelbel, Dortmund (DE)

(73) Assignee: ELMOS Semiconductor SE, Leverkusen (DE)

(21) Appl. No.: 19/570,225

(22) Filed: Mar. 18, 2026

Related U.S. Application Data
(63) Continuation of application No. PCT/EP2024/076349, filed on Sep. 19, 2024.

(30) Foreign Application Priority Data
Sep. 20, 2023 (DE) 10 2023 125 543.6
Sep. 26, 2023 (DE) 10 2023 126 115.0
Sep. 26, 2023 (DE) 10 2023 126 167.3
Sep. 26, 2023 (EP) 23199793.3
Sep. 26, 2023 (LU) LU505175
Jan. 9, 2024 (DE) 10 2024 100 475.4
Mar. 27, 2024 (DE) 10 2024 108 878.8
Jul. 26, 2024 (DE) 10 2024 121 451.1
Sep. 9, 2024 (DE) 10 2024 125 791.1

(51) Int. Cl. H01R 13/66; H01R 13/696

(52) U.S. Cl. CPC H01R 13/6683; H01R 13/6675; H01R 13/696

(57) ABSTRACT

An electrical connector, comprising an electrical contact interface for establishing an electrical contact with another electrical contact interface of another connector, an electrical conductor terminating in the electrical contact interface, and a contact status sensor, wherein the contact status sensor includes a sensor element that can be arranged and is designed to detect a measured value of a predetermined physical parameter of the conductor and/or the contact interface, and a data processing device that is designed to determine an actual status of the electrical contact based on the detected measured value.

### CROSS REFERENCE TO RELATED APPLICATIONS

This application is a continuation application of international patent application PCT/EP2024/076349, filed on Sep. 19, 2024, and designating the U.S., which claims priority to German patent application 10 2023 125 543.6, filed on Sep. 20, 2023, German patent applications 10 2023 126 115.0 and 10 2023 126 167.3, filed on Sep. 26, 2023, European patent application 23 199 793.3, filed on Sep. 26, 2023, Luxembourg patent application LU505175, filed on Sep. 26, 2023, German patent application 10 2024 100 475.4, filed on Jan. 9, 2024, German patent application 10 2024 108 878.8, filed on Mar. 27, 2024 and German patent application 10 2024 125 791.1, filed on Sep. 9, 2024 and German patent application 10 2024 121 451.1, filed on Jul. 26, 2024, each of which are hereby incorporated by reference in their entireties.

### TECHNICAL FIELD

The present disclosure relates to an electrical connector, a communication network with the electrical connector, and a method for operating the electrical connector.

### BACKGROUND

Conventionally, fuses are used in electrical components to protect them from electrical overload. Thermal fuses are also used to protect them from thermal overload. A fuse is an overcurrent protection device that interrupts the circuit by melting a fusible link when the current exceeds a certain value for a sufficient period of time. Such conventional fuses are generally destroyed after tripping and must be replaced. A thermal fuse is an over-temperature protection device that separates two electrical contacts from each other by melting a fusible link and thereby typically releasing stored energy, thus interrupting the circuit when the temperature exceeds a certain temperature value for a sufficient period of time. Such conventional thermal fuses are generally destroyed after they have been triggered and must be replaced.

So-called eFuses or electronic fuses are considered to be a further development of fuse links. These are integrated circuits that can usually replace larger conventional fuses or other protective devices, such as resettable polymer fuses. Electronic fuses are usually housed in small plastic casings (e.g., DFN and flip chip) and feature a control circuit and a power switch (with low switch-on resistance) controlled by the control circuit. The power switch connects the input terminal of the electronic fuse to the connected load in an interruptible manner. If an overload is detected, the control circuit controls the power switch so that it interrupts the power supply to the load. However, the power supply can usually be restored by closing the power switch, so that it is not necessary to replace the electronic fuse.

So-called eThermofuses or electronic thermal fuses are considered to be a further development of thermal fuses. These are integrated circuits that can usually replace larger conventional thermal fuses. Electronic thermal fuses are usually housed in small plastic casings (e.g., DFN and flip chip) and feature a control circuit and a circuit breaker (with low switch-on resistance) controlled by the control circuit. The power switch connects the input terminal of the electronic thermal fuse to the connected load in an interruptible manner. If an overheating status is detected, the control circuit controls the power switch so that it interrupts the energy supply and/or the power supply to the load. However, the energy supply or power supply can usually be restored by closing the circuit breaker, so that it is not necessary to replace the electronic thermal fuse.

The fuses described above can be used in electrical connectors.

An electrical connector is an electromechanical device that serves to establish an electrical connection (for signal transmission and/or power supply) between parts or components of an electrical circuit or between different electrical circuits, thereby combining them into a larger electrical circuit. Components of an electrical circuit are electrically connected if an electrical current can flow between them through an electrical conductor. Most electrical connectors are gender-specific, i.e., the male component is connected to the female component. The connection may be detachable (e.g., in portable electronic devices), require a tool for assembly and/or disassembly, or serve as a permanent electrical connection between two points. An adapter can be used to connect different plugs.

Electrical connectors are therefore used to disconnect and/or connect electrical wires. The connecting parts can be aligned by means of a form fit of the plug parts, fixed in a force-fit manner by spring force (contact foot) and, optionally, additionally secured against unintentional loosening by means of screws. Connectors are a subfield of connection technology. There are many standardized connectors worldwide. A distinction is made between standards for the geometric shape of plugs, sockets, couplings, and outlets on the one hand, and standards for the electrical signal transmitted via cables and connectors on the other.

A growing number of electrically and electronically controlled functions in the vehicle's electrical system leads to a corresponding increase in the number of connectors required. These are required in the vehicle electrical system to connect components, modules, or systems electrically. For connectors in motor vehicles, optionally in automobiles, there is not only a demand-driven growth trend, but also increased requirements for the connectors themselves in terms of quality and reliability - and this under a wide variety of operating statuses, especially with regard to temperature and vibration.

Applications in motor vehicles for traffic and safety-related functions, systems for automated driving and for e-mobility require a high-performance, versatile and secure connection technology for signal transmission and power supply. For example, DE 10 2016 210 721 A1 shows an HV-Interlock plug system with temperature sensor.

Electrical connectors have a wide range of uses in various industries and applications. Here are some well-known uses:

Electronics industry: Connectors are used in electronic devices such as computers, cell phones, tablets, televisions, and household appliances to connect various components to each other.

Automotive industry: Connectors are used in vehicles for various applications such as control systems, sensors, lighting, on-board computers, and more.

Aerospace industry: Connectors are used in aircraft and spacecraft to connect electrical systems, sensors, communication systems, and other electronic components.

Medical technology: Electrical connectors are used in medical devices and instruments such as MRI machines, ultrasound machines, patient monitoring devices, and electrical surgical instruments.

Industrial applications: In industrial applications, connectors are used to connect machines, sensors, actuators, control systems, and other electrical components.

Telecommunications: In telecommunications systems such as networks, telephone systems, cell towers, and fiber optic infrastructure, connectors are used to transmit data and signals.

Renewable energies: In solar power systems, wind turbines, and other renewable energy systems, connectors are used to connect solar modules, wind turbines, inverters, and battery storage systems.

Consumer electronics: Connectors are used in various consumer electronics products such as audio and video equipment, game consoles, cameras, and musical instruments to connect components or attach accessories.

Military and defense industry: In military applications, robust connectors are used to connect electronic equipment such as communication systems, weapon control systems, radar and navigation devices, and vehicle electronics.

Marine and maritime technology: Electrical connectors are used in ships and maritime applications to connect electrical systems, sensors, navigation equipment, communication devices, and control systems.

Energy technology: In energy generation, transmission, and distribution, connectors are used to connect generators, switch cabinets, transformers, switchgear, and other electrical components.

Railway technology: In railway technology, connectors are used to connect signaling systems, rail vehicles, electric drive systems, lighting, and other electronic components.

Building automation: In building automation applications, connectors are used to connect building systems such as lighting, heating, air statusing, security systems, and surveillance cameras.

Robotics and automation: In robot-assisted systems and automated production facilities, connectors are used to connect motors, sensors, control systems, end effectors, and other electrical components.

Research and development: Connectors are used in laboratories and research facilities to connect measuring devices, test equipment, analyzers, and other scientific instruments.

Telecommunications infrastructure: In addition to their use in end devices, electrical connectors are also used in telecommunications infrastructure to connect cables that transmit data and signals between different network components, such as in server rooms, data centers, and telecommunications distribution points.

Security technology: Connectors are used in security systems such as alarm systems, access control systems, video surveillance systems, and fire protection systems to connect sensors, cameras, control systems, and alarm devices.

Event technology and stage lighting: In the event and entertainment industry, connectors are used to connect lighting systems, audio equipment, video devices, special effects, and control systems, both for live events and permanently installed stages.

Air quality monitoring: In air quality monitoring systems, whether in industrial plants, laboratories, or environmental monitoring facilities, connectors are used to connect sensors and measuring devices for detecting air pollutants and other parameters.

Wearable electronics: Small, lightweight connectors are used in wearable electronic devices such as fitness trackers, smartwatches, wearable medical devices, and augmented reality glasses to connect various components and ensure user comfort.

### SUMMARY

An electrical connector is provided, comprising an electrical contact interface for establishing an electrical contact with another electrical contact interface of another connector, an electrical conductor terminating in the electrical contact interface, and a contact status sensor, wherein the contact status sensor includes a sensor element that can be arranged and is designed to detect a measured value of a predetermined physical parameter of at least one of the conductor and the contact interface, and a data processing device that is designed to determine an actual status of the electrical contact based on the detected measured value.

### BRIEF DESCRIPTION OF THE DRAWINGS

In the drawings:

FIG. 1 schematically shows a portion of a communication system according to an embodiment of the disclosure,

FIG. 2 schematically shows the communication system from FIG. 1 when it has a star topology,

FIG. 3 schematically shows the communication system from FIG. 1 when it has a point-to-point topology,

FIG. 4 schematically shows a section of the communication system from FIG. 1,

FIG. 5 schematically shows a flowchart of a method for operating the communication system from FIGS. 1 to 4,

FIG. 6 schematically shows an implementation with electronic switch that is optically controlled,

FIG. 7 schematically shows an exemplary cross-section of an exemplary plug connection,

FIG. 8 schematically shows the exemplary connector STK of FIG. 7 separately as part of a left cable section.

FIG. 9 schematically shows the exemplary socket BUH of FIG. 7 separately as part of a right cable section,

FIG. 10 schematically shows an image of a plug of a first type,

FIG. 11 schematically shows an image of a plug of a second type,

FIG. 12 schematically shows an image of a plug of a third type,

FIG. 13 schematically shows an image of a plug of a fourth type,

FIG. 14 schematically shows an image of a plug of a fifth type,

FIG. 15 schematically shows an image of a plug of a sixth type,

FIG. 16 schematically shows an image of a plug of a seventh type,

FIG. 17 schematically shows an image of a plug of an eighth type,

FIG. 18 schematically shows an image of a plug of a ninth type,

FIG. 19 schematically shows an image of a plug of a tenth type,

FIG. 20 schematically shows an image of a plug of an eleventh type,

FIG. 21 schematically shows an image of a plug of a twelfth type,

FIG. 22 schematically shows an image of a plug of a thirteenth type,

FIG. 23 schematically shows an image of a plug of a fourteenth type,

FIG. 24 schematically shows an image of a plug of a fifteenth type,

FIG. 25 schematically shows an image of a plug of a sixteenth type,

FIG. 26 schematically shows an image of a plug of a seventeenth type,

FIG. 27 schematically shows an image of a plug of an eighteenth type,

FIG. 28 schematically shows an image of a plug of a nineteenth type,

FIG. 29 schematically shows an image of a plug of a twentieth type,

FIG. 30 schematically shows an image of a plug of a twenty-first type,

FIG. 31 schematically shows an image of a plug of a twenty-second type,

FIG. 32 schematically shows an image of a plug of a twenty-third type,

FIG. 33 schematically shows an image of a plug of a twenty-fourth type,

FIG. 34 schematically shows an image of a plug of a twenty-fifth type,

FIG. 35 schematically shows an image of a plug of a twenty-sixth type,

FIG. 36 schematically shows an image of a plug of a twenty-seventh type,

FIG. 37 schematically shows an image of a plug of a twenty-eighth type, and

FIG. 38 schematically shows an image of a plug of a twenty-ninth type.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A contact status sensor for a connector may be provided. The connector comprises an electrical contact interface for establishing electrical contact with another electrical contact interface of another connector, and an electrical conductor that terminates in the electrical contact interface. The contact status sensor comprises a sensor element that can be arranged and designed to detect a measured value of a predetermined physical parameter of the conductor and/or the contact interface. The contact status sensor comprises a data processing device that is designed to determine an actual status of the electrical contact based on the detected measured value.

The contact status sensor may be configured to output, store, hold ready, and/or use the measured value detected by the sensor element.

The physical parameter may comprise a temperature of the conductor. The sensor element may comprise a temperature sensor element that can be thermally coupled to the conductor to detect the temperature of the conductor, and the data processing device may be designed to determine the actual status based on the detected temperature of the conductor.

The physical parameter may include a temperature of the contact interface. The sensor element may comprise a temperature sensor element that is thermally couplable to the contact interface for detecting the temperature of the contact interface, and the data processing device may be configured to determine the actual status based on the detected temperature of the contact interface.

The data processing device may be designed to determine an actual status of the conductor and/or the contact interface based on the detected measured value.

The actual status of the contact may include a probability of failure and/or damage of the electrical plug, optionally of the contact, the contact interface, and/or the conductor.

The data processing device may comprise a computer system (RSYS) with a computer core (μC), wherein the computer core (μC) is configured to perform a computer- and/or machine-implemented method for mapping a measured value vector to the measured value, wherein a measured value vector in this sense comprises at least one first measured value of the output signal value of the one or more first sensor elements (SE1 ) that are thermally coupled to the conductor (LTG), and in each case at least one second measured value of the output signal value of the one or more first sensor elements (SE1 ) that are thermally coupled to the conductor (LTG), and/or in each case at least one first measured value of the output signal value of the one or more first sensor elements (SE1 ) that are thermally coupled to the contact interface (KT), and at least one second measured value of the output signal value of the one or more first sensor elements (SE1 ) that are thermally coupled to the contact interface (KT), and/or exactly one first measured value of the output signal value of the one or more first sensor elements (SE1 ) that are thermally coupled to the conductor (LTG), and, in particular, comprises exactly one second measured value of the output signal value of the one or more first sensor elements (SE1 ) that are thermally coupled to the conductor (LTG), and, in each case, exactly one first measured value of the output signal value of the one or more first sensor elements (SE1 ) that are thermally coupled to the contact interface (KT), and each comprising exactly one second measured value of the output signal value of the one or more first sensor elements (SE1 ) that are thermally coupled to the contact interface (KT), in particular.

The computer system (RSYS) may comprise one or more memories (MEM) with a program code stored there at least temporarily, wherein the computer core (μC) is designed to read and execute this program code when it performs the said computer- and/or machine-implemented method for mapping one or more measured value vectors to one or more measured values of the contact status of the contact interface (KT) and/or one or more predicted values for the measured value of the contact status of the contact interface (KT) and/or one or more temperature measured values for the contact temperature (KT) of the contact interface (KT) and/or one or more temperature measured values for the conductor temperature (LTG) of the conductor (LTG).

The computer- and/or machine-implemented method for mapping one or more measured value vectors to one or more measured values of the contact status of the contact interface (KT) and/or one or more predicted values for the measured value of the contact status of the contact interface (KT) and/or one or more temperature measured values for the contact temperature (KT) of the contact interface (KT) and/or one or more temperature measured values for the conductor temperature (LTG) of the conductor (LTG) comprises a computer- and/or machine-implemented artificial intelligence method, wherein one or more output values of the computer- and/or machine-implemented method for mapping one or more measured value vectors to one or more measured values of the contact status of the contact interface (KT) and/or one or more predicted values for the measured value of the contact status of the contact interface (KT) and/or one or more temperature measurements for the contact temperature (KT) of the contact interface (KT) and/or one or more temperature measurements for the conductor temperature (LTG) of the conductor (LTG).

The computer- and/or machine-implemented method can be used to map one or more measured value vectors to one or more measured values of the contact status of the contact interface (KT) and/or one or more predicted values for the measured value of the contact status of the contact interface (KT) and/or one or more temperature measured values for the contact temperature (KT) of the contact interface (KT) and/or one or more temperature measured values for the conductor temperature (LTG) of the conductor (LTG), a computer- and/or machine-implemented neural network model, whose input values are the one or more measured value vectors and whose one or more output values are one or more measured values of the contact status of the contact interface (KT) and/or one or more forecast values for the measured value of the contact status of the contact interface (KT) and/or one or more temperature measurements for the contact temperature (KT) of the contact interface (KT) and/or one or more temperature measurements for the conductor temperature (LTG) of the conductor (LTG).

The one or more output values may comprise one or more measured values of the contact status of the contact interface (KT) and/or one or more predicted values for the measured value of the contact status of the contact interface (KT) and/or one or more temperature measured values for the contact temperature (KT) of the contact interface (KT) and/or one or more temperature measured values for the conductor temperature (LTG) of the conductor (LTG).

The one or more output values may comprise one or more measured values of a failure or damage probability (PKT) of the contact interface (KT).

The electronic fuse may comprise a control device (CTR) with a computer system (RSYS) with a computer core (μC), wherein the computer core (μC) determines, depending on one or more determined first measured values of the output signal value of the one or more first sensor elements (SE1 ) that are thermally coupled to the conductor (LTG) and/or one or more determined first measured values of the output signal value of the one or more first sensor elements (SE1 ) that are thermally coupled to the contact interface (KT) and/or one or more determined values of the contact status of the contact interface (KT) and/or one or more values of one or more conductor temperatures (LTG) of the electrical conductor (LTG) and/or one or more values of one or more contact temperatures (KT) of the contact interface (KT) and/or one or more of one or more temperature differences (LTG, TK) between a respective value of a conductor temperature (LTG) of the electrical conductor (LTG) and a respective value of a contact temperature (KT) of the contact interface (KT) and/or one or more of one or more temperature differences (LTG, LTG) between a respective value of a first conductor temperature (LTG) of the electrical conductor (LTG) at a first point in time and a respective value of a second conductor temperature (LTG) of the electrical conductor (LTG) at a second point in time and/or one or more of one or more temperature differences (KT, KT) between, in each case, a value of a first contact temperature (KT) of the contact interface (KT) at a first point in time and, in each case, a value of a second contact temperature (KT) of the contact interface (KT) at a second point in time and/or from one or more values derived from these, in particular by temporal derivation and/or temporal integration and/or multiplication with constants and/or other filtering, closes and/or opens a switch (T2) inserted into the line (LTG).

Furthermore, a contact status safety device is provided, which comprises the contact status sensor described above and a switch that can be inserted into the line, wherein the contact status safety device is designed to open and/or close the switch depending on the actual status of the contact.

The disclosure also relates to an electrical connector, wherein the electrical connector comprises the contact status sensor or the contact status protection described above.

The electrical connector may comprise a socket and/or a plug with the contact interface.

The electrical connector may comprise an integrated circuit designed to output a predetermined signal to a communication network connectable to the connector depending on the actual status of the contact.

The integrated circuit may be designed to output the predetermined signal via the contact.

The electrical connector may have a data output interface via which the integrated circuit is designed to output the predetermined signal to the communication network wirelessly and/or via a wired connection.

The connector may have a first power supply module designed to convert thermal energy into electrical energy to supply the integrated circuit with electrical energy, a second power supply module designed to use electromagnetic induction to supply the integrated circuit with electrical energy, and/or an energy storage device for supplying the integrated circuit with electrical energy.

The predetermined signal may comprise information relating to an identifier of the connector and/or information relating to the actual status of the contact, optionally relating to a deviation of the actual status of the contact from a predetermined target status.

The connector may comprise a memory module in which the information relating to the identifier is stored.

It is conceivable that the electrical connector has an electronic fuse and/or a thermal fuse that is designed to trip in the event of a deviation of an actual status of the connector from a predetermined target status of the connector (overcurrent, overvoltage, overtemperature). The electrical connector has an integrated circuit (IC) that is designed to output a predetermined signal to a communication network connectable to the connector when the electronic fuse trips.

Reference is made to the above descriptions, explanations, and definitions, which apply mutatis mutandis to the solution disclosed herein.

An electrical connector can be understood as an electromechanical component. The electrical connector may have a housing, e.g., comprising or consisting of plastic and/or metal. The housing may at least partially accommodate and/or enclose one, several, or all of the components described herein. The connector may be designed to connect conductors to each other and optionally to establish a circuit. The connector may have a “gender,” i.e., it may be a “male” and/or “female” component. The “male” component can be understood as a component, sometimes also referred to as a plug, with outward-facing contacts. The female component, sometimes also referred to as a socket, can be understood as a component with inward-facing contact openings. However, the term “plug” can also be understood broadly in this context as a component that is inserted into a socket permanently attached to another component during assembly, regardless of whether the plug has inward-facing and/or outward-facing contacts. The geometry of the plug and socket can be decisive for their accuracy of fit. The geometry may be specified by national and international standards such as DIN, IEC, or MIL. The connector may be removable, require a tool for installation and/or removal, and/or serve as a permanent electrical connection. The connector may have an adapter or be designed as such, which is configured to couple further (optionally dissimilar) electrical connectors with each other. Various types of connectors are conceivable, such as audio and/or video connectors, industrial connectors, high-frequency connectors, IC sockets or IC mounts, laboratory connectors, card sockets, circuit board connectors, power connectors, high and/or low voltage connectors, telecommunications and/or data technology connectors, crimp connectors, connection terminals, single-wire connectors, and/or terminal blocks.

There are a variety of connector types that can be distinguished based on their specific applications, electrical properties, and mechanical design. Here are some of the most common types of connectors:

Circular connectors: These connectors have cylindrical shapes and are often used in applications where a robust connection is required, such as in aerospace, military technology, and industry. A well-known example is the MIL-DTL-38999 connector.

Rectangular connectors: These have rectangular housings and are versatile. They are used in various industries, including automotive, telecommunications, and industrial applications. One example is the D-sub connector.

Coaxial connectors: These are used to connect coaxial cables for the transmission of high-frequency signals, as used in telecommunications, broadcasting, and data transmission applications. BNC connectors are a commonly used example.

PCB connectors: These are mounted on printed circuit boards and are used to connect PCBs to each other or to connect PCBs to other components. Variants include pin headers, socket headers, IDC (Insulation Displacement Connector) connectors, and many others.

Fieldbus connectors: These are used specifically for industrial automation applications and enable reliable data transmission in harsh environments. Examples include Profibus, CANbus, and Ethernet connectors.

Fiber optic connectors: These are used to connect fiber optic cables and enable the transmission of large amounts of data over long distances. Typical examples are LC, SC, ST, and MTP/MPO connectors.

Audio and video connectors: These are used in audio and video equipment to transmit audio and video signals. Examples include RCA, XLR, HDMI, and VGA connectors.

Power connectors: These are used to supply power to electrical devices and appliances. Typical examples include Schuko, US NEMA, and IEC power plugs.

Terminal connectors: These connectors allow for easy connection of wires or cables without soldering. They are commonly used in electrical installations, household appliances, and lighting systems.

Screw connectors: These connectors use screws to securely connect wires or cables together. They provide a secure mechanical connection and are often used in industrial applications and electrical circuits.

Push-pull connectors: These connectors allow for easy insertion and removal by pushing and pulling the connector. They are commonly found in medical devices, industrial applications, and audio and video equipment.

Magnetic connectors: These use magnets to create a quick and easy connection without the need for physical contacts. They offer a robust and reliable solution for applications that require frequent connections, such as portable devices and charging cables.

Automotive connectors: These are specially designed for use in vehicles and must withstand high vibration, temperature, and humidity requirements. They are used in various vehicle systems such as engines, lighting, electrical systems, sensors, and control units.

Medical connectors: These are used in medical devices and instruments and often have to withstand sterilization procedures. They are used in applications such as patient monitoring, diagnostic equipment, imaging procedures, and surgical instruments.

Fiber optic connectors: These are used specifically for connecting fiber optic cables and ensure precise alignment of the glass fibers for efficient light transmission. They are found in telecommunications networks, data centers, medical imaging systems, and other high-speed networks.

Air- and watertight connectors: These are designed for use in environments with extreme statuses and offer protection against moisture, dust, and other environmental influences. They are used in applications such as aviation, the maritime industry, oil and gas production, and outdoor electronic devices.

Modular connectors: These allow different components and modules to be connected and configured flexibly. They are often used in the electronics industry, telecommunications, and industrial applications.

Thermocouple connectors: These are used to connect thermocouples to measuring devices or control systems. They are crucial for temperature measurement in industrial applications such as oil refineries, power plants, and chemical plants.

Modular connectors for data transmission: These are often used in network applications to connect different types of data cables to each other. They enable flexible configuration of network systems and are used in LANs, WANs, and data centers.

Aviation connectors: These are specially designed for use in aviation and must meet strict requirements for weight, size, vibration, and temperature. They are used in airplanes, helicopters, satellites, and drones.

Power connectors: These are designed for the transmission of high electrical power and are used in applications such as electric vehicles, industrial machinery, high-voltage systems, and control cabinets.

Board edge connectors: These are mounted on printed circuit boards and enable the connection of add-on cards to the motherboard in computers and other electronic devices. They are often used in expansion slots for graphics cards, sound cards, and network cards.

Signal connectors for test and measurement applications: These are used in test and measurement systems to provide a reliable connection between test equipment and devices under test. They offer high signal integrity and are used in laboratories, production environments, and research facilities.

Connectors for industrial networks: These connectors are used in industrial networks such as Ethernet/IP, PROFINET, and EtherCAT to connect industrial automation systems with each other. They offer high reliability and robustness in harsh environments.

Connectors for busbars: These are used to connect busbars to each other and distribute electrical circuits in high-voltage and low-voltage applications. They are used in power distribution systems in buildings, industrial plants, and electric rail vehicles.

Connectors consist of various device parts that serve to establish a secure and reliable connection between the electrical conductors. The most common connector components include:

Plug: The plug is the part of the connector that is inserted into the socket (or mating connector). It contains the electrical contacts that connect to the contacts in the socket to establish the electrical connection.

Socket: The socket is the part of the connector into which the plug is inserted. It also contains electrical contacts that connect with the contacts in the plug to establish the electrical connection.

Contacts: The contacts are the metal parts in the plug and socket that come into contact with each other to allow the flow of electricity. They are usually made of a conductive material such as copper or brass.

Insulators: The insulators are the non-conductive parts of the connector that separate and insulate the electrical contacts from each other to prevent short circuits. They are often made of plastic or ceramic.

Housing: The housing surrounds the plug and socket contacts and protects them from external influences such as dust, moisture, and mechanical stress. It also serves to guide the plug and socket and ensure correct alignment during connection.

Locking mechanisms: Some connectors have locking mechanisms that hold the plug and socket securely together once they are connected. This can be achieved by means of screws, latches, bayonet locks, or other mechanisms.

Seals and gaskets: These are used to seal the connector against the ingress of moisture, dust, and other contaminants. They are particularly important in applications exposed to harsh environmental statuses, such as in aviation, the automotive industry, and industrial applications.

Markings and coding: To avoid confusion and ensure correct connection, connectors may be marked or coded to enable clear identification.

Preferably, the microintegrated circuit is located in the material of the connector's insulator.

The connector may be an audio and/or video connector. Audio and/or video connectors enable the transmission of audio and/or video signals, for example from amplifiers and/or receivers to loudspeakers, headphones, and/or televisions. These signals can be highly interference-prone asymmetrical signals, which require the audio and/or video signals to be shielded against electromagnetic waves. At least one coaxial cable can be used for this purpose. Coaxial cables can have one or more insulated conductors surrounded by a metal braid connected to ground. Typical plugs and sockets in the (analog) audio and/or video sector are two-pin RCA connectors, multi-pin video connectors such as Hosid connectors, and jack plugs and sockets in various sizes with two or more contacts. Jack plugs are quite common in audio technology connections, for example on mixing consoles and power amplifiers. Jack plugs can be designed in straight and angled versions, for example. Lockable XLR connectors are predominantly used for picking up microphone signals. High Definition Multimedia Interface (HDMI) connections can be used specifically for connecting computers, Blu-ray and DVD players, game consoles, and set-top boxes to monitors or televisions. HDMI comprises an interface through which (high-resolution) multimedia content can be transmitted. HDMI carries both the digital HD video signal and the audio signal.

The connector may be an industrial connector. An industrial connector can be understood as a connector for industrial applications. Such a connector can be characterized by mechanical robustness and high-quality workmanship. Industrial connectors can be used, among other things, in the transmission of control signals, for example in automated processing plants and/or in vehicle construction, e.g., in automobile and/or truck construction. Industrial connectors are also used to connect components in photovoltaic systems and in robotics for coupling sensors and/or actuators.

The connector may be a high-frequency connector. A high-frequency connector can be understood as a connector that is suitable for high-frequency applications. In electrical engineering, the high-frequency range can begin above the hearing threshold, i.e., at (approximately) 20 kilohertz. In radio technology and electronics in general, however, the high-frequency range only applies from 30 kilohertz upwards. As a general rule, the higher the frequency, the more sensitive cables and connectors are to electromagnetic radiation. Cables, plugs, and sockets can therefore be shielded. Coaxial conductors can be used for this purpose, e.g., with an impedance/AC resistance of 50 ohms to 75 ohms. The inner insulated conductor can be shielded from the outer conductor by a close-meshed metal mesh. The high-frequency connector itself can be provided with a metallic housing for shielding.

The connector can be an IC socket or an IC mount. ICs can be soldered directly onto the circuit board or not soldered directly onto the circuit board (SMD), but plugged into an IC socket. This has the advantage of easier replacement. The IC sockets or holders required for this, on the other hand, are permanently connected to the circuit board. There are, among others, double-row IC sockets and those with pins on all four sides (PLCC).

The connector may be a laboratory connector. In laboratories, it is important to be able to establish and disconnect electrical connections quickly and safely. A laboratory connector can therefore be a banana plug, an alligator clip, a pole clip, a safety laboratory socket, and/or a short-circuit plug.

The connector may be a card socket. These are regularly used in smartphones, cameras, and/or other portable electronic devices. Card sockets can be designed as flat components. Card sockets can be soldered directly onto the circuit board of the devices. Card sockets may have a slot. The card socket can accommodate predetermined (memory) cards, such as SIM cards, SD and/or MicroSD cards.

The connector may be a circuit board connector. Printed circuit boards may have so-called board-to-board connections, for example to connect a so-called shield or piggyback board to a main board. Board connectors are used for this purpose. The circuit board connector can be, for example, a blade connector, a female connector, a pin board, and/or a socket connector.

The connector can be a power connector or a power plug. Power connectors enable cables and/or devices to be connected to the power supply. Mains connectors can be three-pole with protective contact or two-pole, among other types. Mains connectors also include couplings and/or switchable plugs.

The connector may be a low-voltage connector. Low voltage is an electrical supply voltage in a range with a low risk of dangerous electric shock. It is conceivable that the electrical potential in low voltage between the conductor and earth does not exceed 50 V alternating current (AC) or 120 V direct current (DC). Low-voltage connectors can be used, for example, in power supplies for consumer electronics devices and/or notebooks.

The connector may be a telecommunications and/or data technology connector. There is a wide range of connection systems in this area, such as the D-SUB form (as a serial and/or parallel connection option for PC peripherals) and/or a USB connector. RJ plugs and sockets can be used in the network segment. The RJ45 connector, for example, is found billions of times in Ethernet networks and connects routers and gateways with Ethernet network cards in computers.

The connector can be a crimp connector, a connection terminal, a single-wire connector, and/or a terminal block. Connecting cable wires and strands is part of electrical engineering. In addition to so-called luster terminals, crimp connectors, wire end ferrules, and/or connectors can also be used to connect cable wires and strands, into which a stripped cable is inserted without tools and then held (securely) in place or fixed there. However, cable lugs, round and/or flat plugs, and/or terminal blocks are also conceivable.

An electronic fuse can be understood as a so-called eFuse. It is conceivable that the electronic fuse has a FET. Current can flow to the load through the FET, while a current sensor measures this current by monitoring the voltage across a measuring resistor. It is conceivable that if the measured voltage exceeds a threshold value, the FET is switched off and the current flow (with the exception of FET leakage currents) is stopped. It is conceivable that the electronic fuse is designed to provide short-circuit protection, whereby the current flow is interrupted in milliseconds or even microseconds in the event of a short circuit. It is conceivable that an overcurrent protection value of the electronic fuse can be set via external resistors. It is conceivable that the electronic fuse is designed to automatically/automatically restore the current flow after the overload has subsided. It is conceivable that the electronic fuse is designed to prevent excessive voltage at the load, e.g., by clamping the outputs in the event of rapid voltage increases. It is conceivable that the electronic fuse is designed to suppress an inrush current via a capacitor that sets the rise rate at switch-on to a predetermined value. The electronic fuse may provide at least one of the following functions: short-circuit protection, overcurrent protection, overvoltage protection, reverse current protection, inrush current protection, and/or thermal protection. The electronic fuse may be designed to comply with (national and/or international) safety standards, such as IEC 62368-1. The electronic fuse may include or be connected to a power management IC (PMIC) and/or a microcontroller (MCU). The PMIC can be understood as an integrated circuit that can be used to manage the energy requirements of a system, in this case the fuse.

The triggering of the electronic fuse may involve or consist of the electronic fuse and/or the connector preventing the flow of current through the electronic fuse.

An electronic thermal fuse can be understood as a so-called eThermofuse. It is conceivable that the electronic thermal fuse has a FET. Current can flow to the load through the FET, while a temperature sensor measures the temperature of essential parts of the plug connection by monitoring the temperature, for example, using a thermally sensitive electrical component. It is conceivable that if the measured temperature exceeds a temperature threshold value, the FET is switched off and the flow of current (with the exception of FET leakage currents) is stopped. It is conceivable that the electronic temperature fuse is designed to provide short-circuit protection in the event of contamination of the plug connection by an electrically conductive dirt film and/or overheating protection in the event of corroded or contaminated plug connection contact surfaces, in which the current flow is interrupted in milliseconds or even microseconds in the event of a short circuit or overtemperature. It is conceivable that an overtemperature protection value of the electronic thermal fuse can be set via external resistors, external current sources, and/or by means of programming or the like. It is conceivable that the electronic thermal fuse is designed to automatically/automatically restore the current flow after the overtemperature has subsided. It is conceivable that the electronic thermal fuse is designed to prevent excessive temperatures in the plug connection, e.g., by clamping the outputs in the event of rapid temperature increases. The electronic temperature fuse can provide at least one of the following functions: short-circuit protection, overtemperature protection, undertemperature protection, overcurrent protection, overvoltage protection, reverse current protection, inrush current protection, and/or thermal protection. The electronic temperature fuse may be designed to comply with (national and/or international) safety standards. The electronic temperature fuse may include or be connected to a power management IC (PMIC) and/or a microcontroller (MCU). The PMIC can be understood as an integrated circuit that can be used to manage the energy requirements of a system, in this case the fuse.

The triggering of the electronic thermal fuse may involve or consist of the electronic fuse and/or the connector preventing the flow of current through the electronic fuse.

An IC (short for integrated circuit) can be understood as an electronic circuit (known as a chip) applied to a (optionally thin, e.g., a few millimeters in size) wafer made of semiconductor material. The circuit can be designed as a solid-status circuit or a monolithic integrated circuit. This chip (die) can be encapsulated in a chip package (which may be several times larger) for protection and/or easier contacting. The chip housing may be at least partially the housing of the connector. The IC can be a combination of numerous electrically connected electronic semiconductor components such as transistors, diodes, and/or other active and/or passive components.

A signal is defined as the assignment of information to a measurable physical quantity, such as electrical voltage, sound pressure, or field strength. Signals that do not have a continuous time course are called time-discrete. If time flows continuously in physical systems, only the status variables observed by a measuring system (values of the signal at specific points in time) are time-discrete. If the measurable quantity can only assume a finite number of values, in extreme cases only two such as {on, off}, {light, dark} or {0, 1}, this is referred to as a value-discrete or n-ary (in the case of two values, binary) signal. A signal that is both time-discrete and value-discrete is called a digital signal. In contrast, an analog signal is a signal whose information-carrying quantity can take on continuously variable values. The signal can be an analog and/or digital signal. The signal can be transmitted wirelessly and/or via cable. The signal can carry information. This information can originate from the measurement of a physical process, such as the measurement of a temperature, a current, and/or a voltage. The information can reflect the status of the fuse, for example, “tripped.” The information can be imprinted on the signal using a technical modulation process. In general, the signal can change its magnitude as a function of time and another information-carrying variable. Analog information transmission can be achieved by modulating a (optionally high-frequency) carrier wave, so that the signal is created by changing the amplitude or frequency of the carrier wave (known as amplitude modulation or frequency modulation).

The communication network can be understood as a data connection between the IC of the connector and at least one other device for data processing that is located remotely or externally from the connector. The communication network thus connects the IC of the connector to the outside world. The data connection can be understood as a connection or communication channel through which the information (see above) can be transmitted by means of the signal. A predetermined communication standard can be used for this purpose.

The connector described above has a number of advantages, some of which are explained below by way of example.

As described above, the IC of the connector is designed to output a predetermined signal to a communication network when the electronic fuse trips. This makes it possible to detect outside the connector whether the connector's fuse has tripped. This in turn enables the implementation of a variety of monitoring, analysis, and/or control functions.

For example, it is possible to monitor whether the electrical fuse and/or the thermal fuse of the connector has tripped. For example, it is possible to analyze under which statuses the electrical fuse and/or thermal fuse of the connector has tripped. Furthermore, the transmission of data and/or power in a network can be controlled based on whether the connector's fuse has tripped (whereby the term “control” as used here can also be understood to mean “regulation”).

The electrical connector may have a first contact interface for connecting the connector to a power source and a second contact interface for connecting the connector to a power sink.

The respective contact interface can also be referred to as an interface.

It is conceivable that the electrical connector is electrically conductively connected to the power source via the first contact interface.

It is conceivable that the electrical connector is electrically conductively connected to the current sink via the second contacting interface.

The first and/or second contact interface(s) may be formed at least partially as an outer part of the connector housing.

The first and/or second contact interface(s) may protrude at least partially beyond the housing of the connector.

The first and/or second contact interface(s) may be formed at least partially within the housing of the connector.

It is conceivable that a cable, optionally electrically conductive, can be connected or is connected to at least one of the two contact interfaces, whereby the cable can be electrically conductive, for example because it contains metal. It is conceivable that data in the form of a signal can be transmitted via the cable and/or a supply voltage can be provided.

There are a variety of cable types designed for different purposes and applications. Here are some of the most common types of cables:

Coaxial cable: Coaxial cables consist of a central conductive wire surrounded by an insulating dielectric, which in turn is surrounded by an outer conductive shield. They are often used for the transmission of high-frequency signals, such as in cable television, satellite television, and Ethernet networks.

Twisted pair cable: Twisted pair cables consist of several insulated copper wires twisted together in pairs. They are often used for transmitting data in network cables (e.g., Ethernet cables) and telephone lines.

Fiber optic cables: Fiber optic cables consist of thin glass or plastic fibers that can transmit light signals over long distances. They are often used in telecommunications networks, Internet backbones, and high-speed networks.

Multicore cables: Multicore cables contain several individual cables that are bundled together in an outer sheath. They are often used for complex connections in audio, video, and stage technology, as well as in electronics and industrial automation.

Coaxial speaker cables: These special cables are used to transmit audio signals between amplifiers and speakers. They are often constructed with a central conductive wire surrounded by an insulating dielectric and an outer conductive shield.

Power cables: Power cables are used to transmit electrical energy from a power source to consumers. They are available in various designs, including cables for household appliances, industrial applications, construction sites, and high-voltage lines.

Cables for audio and video equipment: These cables are used to transmit audio and video signals between devices such as televisions, speakers, DVD players, amplifiers, and other audio equipment. Examples include HDMI cables, RCA cables, VGA cables, and optical audio cables.

Instrument cables: These cables are used to connect musical instruments such as guitars, keyboards, and microphones to amplifiers, mixing consoles, and other audio equipment. They are often equipped with a thick insulated jacket and high-quality connectors.

A power supply cable can have various device parts, which can vary depending on specific requirements and the application. Here are some common device components of power cables:

Conductor: The conductor is the part of the cable that carries the electrical current. It is typically made of copper or aluminum and can consist of individual wires (strands) or solid conductors, depending on the flexibility and current requirements of the cable.

Insulation: The insulation surrounds the conductor and serves to isolate the electrical current from the surrounding material and prevent short circuits and current leakage. Insulation materials can be plastics such as PVC (polyvinyl chloride), XLPE (cross-linked polyethylene), or rubber materials.

Sheath: The sheath is the outer layer of the cable that surrounds the conductor and insulation and provides protection against mechanical damage, moisture, chemicals, and other environmental influences. Sheath materials can be PVC, polyethylene, polyurethane, or rubber.

Reinforcement elements: In some cases, cables may contain reinforcement elements that provide additional strength and strain relief. These include steel cables, fabric layers, or aramid fiber reinforcements, which can be used in high-voltage lines and other applications.

Protective layers: For special applications, cables may contain additional protective layers to protect them from extreme statuses such as fire, chemicals, or mechanical stress. These can be fire retardants, chemical resistance coatings, or armor.

Shielding: In some cables, especially in high-frequency applications or near sources of interference, shielding may be used to protect the cable from electromagnetic interference (EMI) and noise. This can be a metallic braided wire shield or a foil shield.

Plugs and sockets: Plugs and sockets may be attached to the ends of the cable to connect to other devices or power sources. These connectors can have a variety of designs and configurations to meet the specific requirements of the application.

A data transmission cable can have various device components, which may vary depending on specific requirements and the type of data transmission. Here are some common components of data transmission cables:

Conductor: The conductor is the part of the cable that carries the electrical signals. Depending on the type of data transmission, these can be copper wires, glass fibers, or other materials.

Insulation: The insulation surrounds the conductor and serves to protect the electrical signals from interference and signal loss. Insulation materials can be plastics such as PVC (polyvinyl chloride), PE (polyethylene), FEP (fluoroethylene propylene), or PTFE (polytetrafluoroethylene).

Sheath: The sheath is the outer layer of the cable that surrounds the conductor and insulation and protects them from mechanical damage, moisture, and other environmental influences. Sheath materials can be PVC, polyurethane, TPE (thermoplastic elastomer), or rubber.

Reinforcement elements: In some cases, data cables may contain reinforcement elements that provide additional strength and strain relief. These include steel cables, fabric layers, or aramid fiber reinforcements, which can be used in high-performance network cables or fiber optic cables.

Shielding: For high-frequency data transmission or in environments with electromagnetic interference, cables may contain shielding to protect the transmission signals from interference and interference. This can be a metallic wire mesh or foil shielding.

Fiber core (in fiber optic cables): In fiber optic cables, the conductor consists of thin glass or plastic fibers that transmit light signals. These fiber cores are surrounded by a protective material that protects them from mechanical damage.

Plugs and sockets: Plugs and sockets can be attached to the ends of the cable to connect to other devices or network components. These connectors can have a variety of designs and configurations, depending on the type of data transmission and the requirements of the application.

It is conceivable that at least one of the two contact interfaces is designed in such a way that it can be inserted into a socket or another interface with predetermined dimensions so that, after insertion, a predetermined part of the socket or the other interface and a predetermined part of this contact interface are connected to each other, optionally electrically conductive and/or mechanically, optionally connected to each other in a form-fitting and/or force-fitting manner.

It is conceivable that at least one of the two contact interfaces is designed in such a way that a further interface with predetermined dimensions can be inserted into it in such a way that, after insertion, a predetermined part of the further interface and a predetermined part of this contact interface are connected to each other, optionally electrically conductive and/or mechanically, optionally form-fitting and/or force-fitting.

It is conceivable that the first and second contact interfaces are electrically conductive, optionally for transmitting data in the form of a signal and/or for providing a supply voltage.

It is conceivable that the first and second contact interfaces are designed to be electrically conductive, optionally for transmitting data in the form of a signal and/or for receiving a supply voltage, and can be connected to a further interface.

The integrated circuit may be electrically conductively connected to the first and/or second contact interface for the purpose of supplying it with electrical energy.

In other words, it is conceivable that the integrated circuit draws or extracts the electrical energy it requires during operation from the electrical energy transmitted via the connector. It is conceivable that the electrical energy is drawn from a (data) signal transmitted via the connector. It is also conceivable, additionally or alternatively, that this electrical energy is drawn from a supply voltage transmitted via the connector.

This has the advantage that an additional power supply does not necessarily have to be provided for the integrated circuit of the connector. The solution disclosed can thus be implemented in all existing connectors without having to change their standardized design.

The integrated circuit can be designed to output the predetermined signal to the communication network via the first and/or second contact interface when the electronic fuse trips.

In other words, it is conceivable that the first and/or second interface could be used to output the predetermined signal as soon as the electronic fuse trips.

This in turn has the advantage that existing and standardized connector interfaces can be used for signal transmission. The solution disclosed can thus be implemented in all existing connectors without having to change their standardized design.

The electrical connector may have an interface for data output via which the integrated circuit is designed to output the predetermined signal wirelessly and/or wired to the communication network.

As described above, the interface for data output may be one or both of the contact interfaces, but may also be another interface.

The provision of the additional interface offers the advantage that even if one of the two contact interfaces malfunctions, which could interfere with the transmission of the predetermined signal in the event of the electronic fuse being triggered, the predetermined signal can still be output via the additional interface.

The provision of the interface for data output also has the advantage that existing and standardized interfaces of connectors can be used for signal and/or current transmission during regular operation of the connector. The solution disclosed can thus be implemented in all existing connectors without having to change their standardized design.

The connector may have a first power supply module designed to convert thermal energy into electrical energy to supply the integrated circuit with electrical energy.

The provision of such a first power supply module offers, among other things, the advantage that the energy responsible for triggering the electronic fuse can itself be used to supply power to the integrated circuit. This allows the integrated circuit to be operated independently of a current or data flow through the connector. The solution disclosed can therefore be implemented in all existing connectors without affecting communication and/or power transmission via the connector. The solution disclosed can be combined not only with all existing standardized connectors, but also with all standardized communication and power transmission standards. Furthermore, the integrated circuit can also be operated if no energy is otherwise available at the connector, for example due to an interrupted current flow through the connector.

The connector may have a second power supply module designed to use electromagnetic induction to supply the integrated circuit with electrical energy. It is conceivable that the second power supply module has a coil.

The electrical energy can be drawn from a current and/or data flow through the connector, but can also, additionally or alternatively, come from an external power source relative to the connector. One advantage of such a second power supply module is that the integrated circuit can be powered wirelessly. The solution disclosed can therefore be implemented in all existing connectors.

The connector may have an energy storage device for supplying the integrated circuit with electrical energy.

The energy storage device can be used to store energy that is currently available but not needed for later use. The energy storage device can be designed to convert the form of energy for storage and/or release. It is conceivable that the energy storage device is designed to convert electrical energy into chemical energy during charging or storage and/or to convert chemical energy into electrical energy during discharge or unloading. It is conceivable that the energy storage device is additionally or alternatively designed to convert electrical energy into thermal energy during charging or storage and/or to convert thermal energy into electrical energy during discharge or unloading. It is conceivable that the energy storage device is additionally or alternatively designed to convert electrical energy into mechanical energy during charging or energy storage and/ly convert mechanical energy into electrical energy during discharge or energy release. The energy storage device may be designed to store energy in the form of electrical, thermal, and/or mechanical energy, optionally potential energy. The energy storage device may comprise a capacitor and/or an inductor and/or an electrochemical cell and/or a battery and/or an accumulator and/or a nuclear battery (betavoltaic cell) for storing energy

There are various types of electrical energy storage devices, which can be distinguished according to their operating principles, capacity, application, and other factors. Examples include

Batteries: Batteries are one of the most widely used forms of energy storage. They consist of one or more galvanic cells that convert chemical energy into electrical energy. Batteries come in various chemical types, including lead-acid, lithium-ion, nickel-cadmium, nickel-metal hydride, and others.

Capacitors are energy storage devices based on electrostatic principles. They can store a certain amount of electrical charge and release it quickly, making them particularly suitable for applications with high power density. Compared to batteries, capacitors have very high cycle stability and fast charging and discharging times, but lower energy density. For example, it is conceivable that the integrated circuit of a connector rectifies data levels on a data line of the connector, thereby charging a capacitor of the connector, which in turn supplies the integrated circuit with electrical energy.

Supercaps (supercapacitors): Supercaps are energy storage devices based on electrostatic principles. They can store a large amount of electrical charge and release it quickly, making them particularly suitable for applications with high power density. Compared to batteries, supercaps have very high cycle stability and fast charging and discharging times, but lower energy density.

Liquid batteries: Liquid batteries use liquid electrolytes to store electrical energy. They can store large amounts of energy but are more suitable for stationary energy storage applications, such as grid stabilization and renewable energy storage.

Redox flow batteries: Redox flow batteries are a type of liquid battery in which the electrochemical reactions take place in external tanks. They are particularly well suited for long-term energy storage and can store large amounts of energy.

Thermal storage: Thermal storage systems store energy in the form of heat. They can absorb heat from renewable energy sources such as solar energy or surplus electrical energy and release it later to generate thermal energy. Examples include sensitive heat storage, latent heat storage, and thermochemical storage. They require a thermally insulated connector housing.

Pressure storage: Pressure storage systems store energy by compressing a gas or liquid. They are often used in hydraulic systems to store energy and release it later to perform mechanical work. They require a microfluidic pump to generate pressure in the connector and a microfluidic/electrical pressure-to-electrical energy converter in the connector, as well as a pressure accumulator in the connector.

Micromechanical flywheels: Flywheels are rotating and/or oscillating masses that can store kinetic energy. They are often used in combination with electric motors and/or comb drives and generators to store excess energy and release it later.

Mechanical springs: Mechanical springs can store potential energy that can later be converted into kinetic energy. They are used in various applications such as mechanical watches, vehicles, and special applications. They are preferably coupled with an electromagnetic and/or electrostatic micromechanical motor, such as a comb drive.

One advantage of providing the energy storage device is that, in the event of a contact problem at the contact interface of the connector, the direct power supply to the integrated circuit of the connector can be interrupted if necessary. This would cause the integrated circuit to lose its ability to communicate with a higher-level control unit via a data bus. However, reporting such contact problems is precisely the task of such an integrated circuit. The analogous problem occurs when the fuse is triggered. Depending on the size of the energy storage device, the integrated circuit can be operated autonomously or independently of an external power supply to the connector for a certain period of time thereafter using the energy stored in the connector's energy storage device. This allows the integrated circuit of the connector to send the predetermined signal even when no other power supply is available for the integrated circuit. The predetermined signal preferably comprises a problem designation, an identification of the integrated circuit and thus of the connector (identifier) and, if necessary, further information and, if necessary, further measured values. Furthermore, the energy storage device can be charged in such a way that energy is drawn from a system (in one or more of the ways described above) in such a small amount that the system is not affected. This can also be advantageous, among other things, when energy is to be extracted from a data signal.

Preferably, the integrated circuit comprises a computer system. Preferably, the computer system comprises a computer core (CPU) that communicates via an internal data bus with one or more volatile and/or non-volatile memories and a data interface. By means of the data interface, the computer core and/or the integrated circuit can preferably communicate with a higher-level control device via a wired and/or wireless data transmission channel. This communication can be digital and/or analog. Preferably, program code for the computer- and/or machine-implemented processes executed by the plug connection, and preferably by the computer core (CPU) of the computer system of the plug connection, is stored at least intermittently in one or more memories of the computer system. Typically, the computer core (CPU) of the computer system reads such program code in one or more memories of the computer system and executes it in order to execute one or more computer-implemented and/or machine-implemented processes. In doing so, the computer core (CPU) accesses other device parts of the connector and/or the integrated circuit of the connector directly via the data bus or indirectly by means of other device parts of the connector, in order to execute the machine-implemented method parts of the computer- and/or machine-implemented methods.

An exemplary first other device part of the integrated circuit and/or the connector may be, for example, an analog-to-digital converter for detecting electrical parameters of the connector and/or device parts of the connector. Preferably, such an analog-to-digital converter is part of the integrated circuit of the connector. Preferably, the computer core (CPU) can access the analog-to-digital converter via the internal data bus of the integrated circuit. Preferably, the computer core (CPU) can control the analog-to-digital converter via the internal data bus of the integrated circuit. Preferably, the computer core (CPU) can read out measured values from the analog-to-digital converter via the internal data bus of the integrated circuit.

An exemplary second other device part of the integrated circuit and/or the connector may be, for example, a test current source for feeding or withdrawing an electrical test current into a contact interface of the connector. If the socket and plug of a plug connection are each equipped with such an integrated circuit with such an integrated test current source, then one of the at least two connectors of a plug connection, e.g., the plug, can feed an electrical test current into its contact interface. If the socket and plug of a plug connection are each equipped with such an integrated circuit with such an integrated test current source, the other connector of the at least two connectors of the plug connection, e.g., the socket, can withdraw this electrical test current from its contact interface. If the contact interfaces of the connectors of the plug connection are not electrically connected to each other, the electrical potentials of the respective contact interfaces dissipate. The respective computer core (CPU) of the computer system of the respective plug connection can detect these changes in the respective electrical potential of the respective contact interface, for example, by means of the respective analog-to-digital converter and conclude, by means of a computer- and/or machine-implemented method, that there is insufficient electrical contact at its respective contact interface.

An exemplary third other device part of the integrated circuit and/or the connector may be, for example, a sensor element for detecting a physical parameter of the connector.

A first such physical parameter may be, for example, the temperature of the contacting interface. This has the advantage that the computer core (CPU) can detect a temperature increase over time, for example, by means of a computer- and/or machine-implemented process and typically by means of an analog-to-digital converter and, if necessary, other device parts such as filters and amplifiers, detect a temperature increase, e.g., over time, and, if necessary, report it to a higher-level control system via the data interface and/or counteract the further temperature increase by means of actuators, e.g., an electronic switch or the like, for example by interrupting the flow of electrical current through the contact interface or the like. Preferably, the computer core (CPU) of the connector's computer system transmits information about this countermeasure and/or the measured values recorded and/or the information determined to the higher-level control system and/or other computer cores (CPUs) of other computer systems of one or more connectors via the data interface and the data transmission channel this data interface. This has the advantage that the faulty plug connection becomes known to the overall system, of which the connector is typically a part, and other connectors and/or the higher-level control device and/or other device parts of this overall system can take countermeasures against the effects of these countermeasures of the computer core (CPU) of the connector's computer system and/or the computer cores of other computer systems of other connectors and/or the higher-level control device and/or other devices of the overall system, for example by establishing alternative electrical connections by closing and/or opening other electronic switches in the network of the overall system and/or by or decommissioning device parts of the overall system, such as switching on and/or off energy sources and/or electrical consumers in the network of the overall system and/or changing the topology of a network of the overall system. Preferably, the plug connection detects the temperature of the contact interface and/or the housing of the plug connector and/or the conductor that is electrically connected to the contact interface, and/or the temperature of the integrated circuit of the plug connector and/or other device parts of the plug connector.

It is conceivable that the computer core (CPU) of the connector's computer system and/or the higher-level control device evaluates one or more time sequences of one or more detected temperatures of one or more temperature sensors and/or one or more temperature differences in the connector and/or in the plug connection and/or in the overall system by means of a computer- ed and/or machine-implemented method. The computer core (CPU) of the connector's computer system can also evaluate and take into account measured values from other connectors in the network that are transmitted via the data transmission channel and/or the associated data network. If one or more temperature curves and/or one or more temperature differences and/or one or more temperature measurements of one or more temperatures indicate a defect and/or an impending defect in the connector and/or the plug connection of which the connector is typically a part, the computer core (CPU) of the computer system of the connector and/or the higher-level control unit can initiate the countermeasures described above, which are not repeated here but are considered to be disclosed. For this purpose, the computer core (CPU) of the connector's computer system and/or the higher-level control unit may, if necessary, execute a computer- and/or machine-implemented artificial intelligence method, for example one or more neural network models. In the case of a neural network model, the input signals of the neural network model may include, among other things the temperature measurements and/or temperature curves and, if applicable, other measurements and/or measurement curves from one or more other sensors and, if applicable, other data, and the output signals can be one or more probabilities of one or more specific error statuses and/or one or more permissible operating statuses. The computer system and/or the higher-level control system conclude that there is an error if one or more of these probabilities lies outside a permissible range of values for the respective probability. In the event of such a fault, the computer system of the plug connection and/or the higher-level control unit preferably initiate the aforementioned countermeasures and, if necessary, the aforementioned signals.

A second such physical parameter can be, for example, the surface conductivity of the housing. This has the advantage that the computer core (CPU) can detect a change in the surface and/or volume conductivity of the housing of the connector and/or the connector connection of at least two connectors by means of a computer- and/or machine-implemented process and typically by means of an analog-to-digital converter and a voltage source, in particular the integrated circuit of the connector and/or a current source of the integrated circuit of the connector, and preferably by means of an external contact of the connector and, if necessary, other device parts such as filters and amplifiers, can detect a change in the surface and/or volume conductivity of the housing of the connector and/or the plug connection of at least two connectors. Such a change can be detected, for example, by the computer core (CPU) of the computer system of the connector and/or a higher-level control system and/or the computer core of a computer system of another connector and/or another plug connection, e.g., over time, based on detected conductivity data and/or resistance values and/or voltage values and/or current values in connection with this external contact.

If necessary, the computer core (CPU) of the connector's computer system can report one or more measured values for the voltage between the external contact and the contact interface or the potential of a reference node via the data interface to a higher-level control system and/or the computer core of another computer system of another connector and/or a higher-level control system, including the current value of a test current fed into the external contact. including the current value of a test current fed into the outer contact.

A test current source of the connector, which is preferably controlled by the computer core (CPU) of the connector's computer system via the data bus of the connector's integrated circuit, preferably feeds this test current typically into the outer contact.

Preferably, the computer core (CPU) of the connector's computer system executes a computerand/or machine-implemented voltage measurement program for this leakage voltage between the outer contact on the one hand and the contact interface or a node on a reference potential on the other.

For example, the computer core (CPU) of the connector's computer system can calculate conductivity and/or resistance values from the recorded voltage values.

The computer core (CPU) of the connector's computer system, and thus the connector's computer system and thus the connector, are therefore preferably equipped with execute a computer- and/or machine-implemented voltage and/or resistance and/or conductivity measurement program for this leakage voltage and/or this leakage resistance value and/or this leakage conductivity value between the outer contact on the one hand and the contacting interface or a node at a reference potential on the other.

This has the advantage that the connector or these device parts can detect critical contamination, electrically conductive wetting and leakage voltages and/or leakage resistances and/or leakage conductivities by executing computer- and/or machine-implemented analysis methods based on these measured values and by computerand/or machine-implemented comparison of one or more of the recorded and/or determined measured values with one or more respective permissible measured value ranges, and can accordingly take countermeasures and send signals to the users and the aforementioned higher-level control unit.

This reduces hazards such as fire development and/or ensures adequate protection against contact.

If necessary, the computer core (CPU) of the connector's computer system can transmit one or more measured values for the electrical current (leakage current) in the outer contact via the data interface to a higher-level control system and/or the computer core of another computer system of another connector and/or a higher-level control system, including, if necessary, the voltage value for the electrical voltage between the outer contact and the contact interface or a node at a reference potential.

A test voltage source of the connector, which the computer core (CPU) of the computer system of the connector preferably controls via the data bus of the integrated circuit of the connector, preferably applies this test voltage typically between the outer contact and the contact interface or a node on a reference potential.

Preferably, the computer core (CPU) of the connector's computer system executes a computerand/or machine-implemented current measurement program for this leakage current between the outer contact on the one hand and the contact interface or a node at a reference potential on the other.

For example, the computer core (CPU) of the connector's computer system can calculate conductivity and/or resistance values from the recorded current values.

The computer core (CPU) of the connector's computer system, and thus the connector's computer system and thus the connector, are thus preferably equipped with execute a computerand/or machine-implemented current and/or resistance and/or conductivity measurement program for this leakage current into the outer contact and/or this leakage resistance value and/or this leakage conductivity value between the outer contact on the one hand and the contacting interface or a node at a reference potential on the other.

This has the advantage that the connector or these device parts can detect critical contamination, electrically conductive wetting and leakage currents and/or leakage resistances and/or leakage conductivities by performing computer- and/or machine-implemented analysis methods based on these measured values and by computerand/or machine-implemented comparison of one or more of the recorded and/or determined measured values with one or more respective permissible measured value ranges, and can accordingly take countermeasures and send signals to the users and the aforementioned higher-level control unit.

The computer core (CPU) of the computer system of the connector and thus the computer system of the connector and thus the connector are thus preferably configured to execute a computer- and/or machine-implemented current measurement program for this leakage current between the outer contact on the one hand and the contact interface or a node on a reference potential on the other.

This has the advantage that the connector or these device parts can detect critical contamination and leakage currents and can take appropriate countermeasures and send signals to the users and the aforementioned higher-level control unit.

This reduces hazards such as fire development and/or ensures adequate protection against contact.

If necessary, the computer core (CPU) of the connector's computer system and/or the higher-level control unit and/or one or more computer cores of other connectors and/or other device parts of the overall system can be protected against the dangers of such leakage currents, leakage voltages, and insufficient contact protection by means of actuators, e.g., one or more electronic switches or the like, for example by interrupting the flow of electrical current through the contact interface of the connector or the like, to counteract the dangers of such leakage currents, leakage voltages, insufficient leakage resistances, and/or insufficient leakage conductivities and the associated dangers. Preferably, the computer core (CPU) of the computer system of the connector and/or the relevant computer cores of the relevant computer systems of the relevant other connectors of the overall system transmit information about this countermeasure and/or the measured values recorded and/or the information determined to the higher-level control system and/or other computer cores (CPU) of other computer systems of one or more connectors via the data interface of the connector or the relevant data interfaces of the relevant connectors and the relevant respective data transmission channel, preferably to the higher-level control system and/or other computer cores of other computer systems of other connectors and/or the computer core (CPU) of the connector's computer system. This has the advantage that the faulty plug connection becomes known to the overall system, of which the connector is typically a part, and its leakage problem, and other connectors and/or the higher-level control device and/or other device parts of this overall system take countermeasures against the effects of these countermeasures of the computer core (CPU) of the connector's computer system and/or the computer cores of other computer systems of other connectors and/or the higher-level control device and/or other devices of the overall system, for example by establishing alternative electrical connections by closing and/or opening other electronic switches in the network of the overall system and/or by or decommissioning device parts of the overall system, such as switching on and/or off energy sources and/or electrical consumers in the network of the overall system and/or changing the topology of a network of the overall system. Preferably, the plug connection detects the leakage current and/or the leakage voltage and/or the leakage resistance and/or the leakage conductance of the outer contact relative to the contact interface and/or the conductor that is electrically connected to the contact interface, and/or the integrated circuit of the connector and/or relative to a reference node of the connector at a reference potential and/or relative to other device parts of the connector. Preferably, the computer core (CPU) of the computer system of the connector reports one or more of these values via the data interface of the connector to the higher-level control system and/or other computer cores of other computer systems of other connectors and/or to other device parts of the overall system. Such other device parts of the overall system can be, for example, control devices for electronic switches and/or control devices for electronic fuses or the like.

A third such physical parameter can be, for example, the electrical conductivity of the housing material of the connector housing. This has the advantage that the computer core (CPU) can detect a change in the preferably complex volume conductivity of the housing of the plug connector and/or the plug connection of at least two plug connectors by means of a computerand/or machine-implemented method and typically by means of an analog-to-digital converter and a voltage source, in particular the integrated circuit of the plug connector and/or a current source of the integrated circuit of the plug connector and preferably by means of a pair of electrodes of the plug connector and, if necessary, other device parts such as filters and amplifiers, can detect a change in the preferably complex volume conductivity of the housing of the connector and/or the plug connection of at least two connectors. Such a change can be detected, for example, by the computer core (CPU) of the computer system of the connector and/or a higher-level control system and/or the computer core of a computer system of another connector and/or another plug connection and/or another device of the overall system z.B. over time based on recorded conductivity data and/or resistance values and/or voltage values and/or current values in connection with this electrode pair. The said external contact can be used as an electrode of such an electrode pair. However, this is not optimal in that the change in the housing material cannot be separated from the change in surface conductivity. A contact of the contact interface can be an electrode of such an electrode pair. This case also has disadvantages with regard to the separation of surface conductivity and volume conductivity.

If necessary the computer core (CPU) of the connector's computer system may report one or more measured values for the voltage between the electrodes of the electrode pair via the data interface to a higher-level control system and/or the computer core of another computer system of another connector and/or a higher-level control system and/or another device part of the overall system, including the current value of a test current fed into the external contact. including the current value of a test current fed into the outer contact.

A test current source of the connector, which is preferably controlled by the computer core (CPU) of the computer system of the connector via the data bus of the integrated circuit of the connector, preferably feeds this test current typically into one electrode of the electrode pair and preferably removes this test current from the other electrode of the electrode pair. The connector may have several electrode pairs. Preferably, two electrode pairs of these electrode pairs do not have more than one electrode in common.

Preferably, for the purpose described above, the computer core (CPU) of the computer system of the connector executes a computer- and/or machine-implemented voltage measurement program for this measured voltage between the electrodes of the relevant electrode pair of the connector.

For example, the computer core (CPU) of the connector's computer system can preferably calculate complex conductivity and/or resistance values for the housing material of the connector's housing from the recorded voltage values. Preferably, the computer core of the computer system of the connector can cause the test current source to modulate the fed-in measurement current with a preferably but not necessarily monofrequent modulation spectrum. This allows the computer core of the connector's computer system to determine, for example, the phase angle between the injected measurement current and the measurement voltage thereby dropping between the electrodes of the electrode pair by means of the analog-to-digital converter and/or special measuring devices, and thus determine the said typically complex measured value.

The computer core (CPU) of the computer system of the connector and thus the computer system of the connector and thus the connector are thus preferably designed execute a computer- and/or machine-implemented voltage and/or resistance and/or conductivity measurement program for this complex measurement voltage and/or this complex material resistance value and/or this complex material conductivity value between the electrodes of the electrode pair.

This has the advantage that the connector and/or the computer cores of other connectors and/or the higher-level control unit and/or other device parts of the overall system critical degradation material changes, material stretching and/or material compression and/or material breakage events and/or internal, in particular complex leakage voltages and/or internal, in particular complex leakage resistances and/or internal, in particular complex leakage conductances by performing computer- and/or machine-implemented analysis procedures based on these measured values and by computerand/or machine-implemented comparison of one or more of the recorded and/or determined measured values with one or more respective permissible measured value ranges, and can accordingly take countermeasures and send signals to the users and/or the computer cores of other connectors and/or the higher-level control unit and/or other device parts of the overall system.

This reduces hazards such as housing breakage and/or insufficient electrical insulation capacity of the connector housing.

If necessary, the computer core (CPU) of the connector's computer system can transmit one or more measured values for one or more material parameters of the connector housing material and/or one or more measured values for the electrical properties of one or more electrode pairs of the connector electrode pairs and/or or one or more values derived from these via the data interface to a higher-level control system and/or the computer core of another computer system of another connector and/or a higher-level control system and/or one or more other device parts of the overall system, including, if necessary, the voltage value for the electrical voltage between the electrodes of the electrode pair.

A test voltage source of the connector, which the computer core (CPU) of the computer system of the connector, preferably via the data bus of the integrated circuit of the connector, preferably applies this complex test voltage typically between the electrodes of one or more electrode pairs of the connector in the housing material of the connector housing.

Preferably, the computer core (CPU) of the computer system of the connector executes a computer- and/or machine-implemented current measurement program for this measurement current between the electrodes of the one or more electrode pairs.

For example, the computer core (CPU) of the connector's computer system can calculate complex material conductivity and/or complex material resistance values from the recorded complex current values.

The computer core (CPU) of the connector's computer system and thus the connector's computer system and thus the connector and/or the higher-level control unit and/or one or more computer cores of other computer systems of other connectors and/or connector connections and/or other device parts of the overall system are thus preferably configured execute a computer- and/or machine-implemented current and/or resistance and/or conductivity measurement program for one or more complex measurement currents and/or one or more complex material resistance values and/or one or more complex material conductivity values between the electrodes of one or more electrode pairs in the housing material of the housing.

This has the advantage that the computer core of the connector's computer system and/or the higher-level control unit and/or one or more other computer cores of one or more other computer systems of one or more other connectors and/or one or more other device parts of the overall system can detect critical housing material changes, such as aging, corrosion, breakage, stretching, compression, plastic deformation, contamination due to diffusion in or out, etc., and/or internal complex leakage currents and/or internal complex housing material resistances and/or internal complex housing material conductances by performing computer- and/or machine-implemented analysis procedures based on these measured values and by computerand/or machine-implemented comparison of one or more of the recorded and/or determined measured values with one or more respective permissible measured value ranges, and can accordingly take countermeasures and send signals to the users and the aforementioned higher-level control unit and/or other computer cores of other computer systems of other connectors and/or other device parts of the overall system.

The computer core (CPU) of the computer system of the connector and thus the computer system of the connector and thus the connector and/or the higher-level control unit and/or other computer cores of other computer systems of other plug devices and/or plug connections and/or other device parts of the overall system are thus preferably designed execute a computer- and/or machine-implemented material measurement program for these material parameters of the housing material of the plug connection by means of device parts of the connector.

This has the advantage that the computer core (CPU) of the computer system of the plug connector and thus the computer system of the plug connector and thus the plug connector and/or the higher-level control unit and/or other computer cores of other computer systems of other plug devices and/or plug connections and/or other device parts of the overall system can detect critical housing material changes as described above and can take appropriate countermeasures and send signals to the users and the aforementioned higher-level control unit.

This reduces risks such as fatigue fractures and/or changes in electrical properties without warning.

If necessary, the computer core (CPU) of the computer system of the plug connection and/or the higher-level control unit and/or one or more computer cores of other plug connections and/or other device parts of the overall system can be used to counteract the risks of such housing material changes and the associated dangers by means of actuators, e.g., one or more electronic switches or the like, for example by interrupting the flow of electrical current through the contact interface of the connector or the like. Preferably, the computer core (CPU) of the computer system of the connector and/or the relevant computer cores of the relevant computer systems of the relevant other connectors of the overall system and/or other device parts of the overall system and/or the higher-level control unit transmit information about this countermeasure and/or the measured values recorded and/or or the information determined to the higher-level control system and/or other computer cores (CPU) of other computer systems of one or more other connectors and/or other device parts of the overall system via the data interface of the connector or the relevant data interfaces of the relevant connectors or their respective data interfaces and via the relevant respective data transmission channel of this respective relevant data interface, preferably to the higher-level control system and/or other computer cores of other computer systems of other connectors and/or the computer core (CPU) of the computer system of the connector and/or other device parts of the overall system. This has the advantage that the faulty plug connection becomes known to the overall system, of which the connector is typically a part, and whose housing problem is known, and other connectors and/or the higher-level control device and/or other device parts of this overall system can take countermeasures against the effects of these countermeasures of the computer core (CPU) of the connector's computer system and/or the computer cores of other computer systems of other connectors and/or the higher-level control device and/or other devices of the overall system, for example by establishing one or more alternative electrical connections by closing and/or opening other electronic switches in the network of the overall system and/or by or decommissioning device parts of the overall system, such as switching on and/or switching off energy sources and/or electrical consumers in the network of the overall system and/or changing the topology of a network of the overall system. Preferably, the plug connection detects the complex measurement current and/or the complex measurement voltage and/or the complex material resistance and/or the complex material conductance between the electrodes of the electrode pair of the plug connector. Preferably, the computer core (CPU) of the computer system of the plug connector reports one or more of these values via the data interface of the plug connector to the higher-level control system and/or other computer cores of other computer systems of other plug connectors and/or to other device parts of the overall system. Such other device parts of the overall system can be, for example, control devices for electronic switches and/or control devices for electronic fuses or the like.

It is conceivable that the computer core (CPU) of the computer system of the connector and/or the higher-level control device stores one or more time sequences of one or more recorded complex voltage measurements and/or current measurements and/or complex material resistance values and/or complex material conductivity values between the electrodes of an electrode pair in the housing material of the connector and/or one or more differences between different electrodes in the connector and/or in the plug connection and/or in the overall system by means of a computer- and/or machine-implemented method. In doing so, the computer core (CPU) of the connector's computer system and/or one or more computer cores of other computer systems of other connectors and/or the higher-level control unit and/or other device parts of the overall system can also evaluate and take into account measured values of other connectors and/or other device parts in the network that are transmitted via the data transmission channel and/or the associated data network. If one or more measured value curves and/or the curves of measured values derived from them and/or one or more measured value differences and/or one or more measured values of one or more of these measured values indicate a defect and/or an impending defect in the housing of the connector and/or the plug connection of which the connector is typically a part, the computer core (CPU) of the connector's computer system and/or the higher-level control unit and/or one or more other computer cores of other computer systems of other connectors and/or one or more device parts of the overall system can initiate, among other things, the countermeasures described above, which are not repeated here but are considered to be disclosed. For this purpose, the computer core (CPU) of the connector's computer system and/or the higher-level control unit and/or one or more other computer cores of other computer systems of other connectors and/or one or more device parts of the overall system may, if necessary, each execute a computer- and/or machine-implemented artificial intelligence method, for example one or more neural network models. In the case of a neural network model, the input signals of the neural network model can include the aforementioned measured values and/or the aforementioned curves of such measured values and, if applicable, further measured values and/or measured value curves of one or more other sensors in the connector and/or in other connectors and/or in the higher-level control unit and/or in other device parts of the overall system and, if applicable, other data, and the output signals can be one or more probabilities of one or more specific error statuses and/or one or more permissible operating statuses of the connector and/or the plug connection and/or the overall system. The computer core of the computer system and/or the higher-level control system and/or one or more other computer cores of other computer systems of other plug connections and/or one or more device parts of the overall system detect a fault if one or more such probabilities lie outside a respective permissible value range for the respective probability. In the event of such a fault, the computer core of the computer system of the plug connection and/or the higher-level control device and/or one or more other computer cores of other computer systems of other plug connections and/or one or more device parts of the overall system preferably initiate the said countermeasures and, if necessary, carry out the said signaling.

One or more fourth such physical parameters may be, for example, mechanical stress parameters of the connector housing. This has the advantage that the computer core (CPU) can use a computer- and/or machine-implemented process and typically an analog-to-digital converter and an electromechanical and/or microelectromechanical sensor, which as a MEMS sensor may also be a co-integrated part of the integrated circuit of the connector, and, if necessary, other device parts such as filters and amplifiers, can detect a change in the mechanical load on the housing and/or the contact interface, e.g., due to shear stress, tensile stress, pressure, torsion, etc., of the housing of the connector and/or the plug connection of at least two connectors. Such a change can be detected, for example, by the computer core (CPU) of the connector's computer system and/or a higher-level control system and/or one or more computer cores of one or more other computer systems of one or more other connectors and/or one or more other plug connections, e.g. over time on the basis of recorded measured values of the corresponding mechanical variables and/or the corresponding electrical parameters of the corresponding sensor signals of the corresponding sensors.

If necessary, the computer core (CPU) of the connector's computer system can report one or more measured values of one or more mechanical variables via the data interface to a higher-level control system and/or the computer core of another computer system of another connector and/or a higher-level control system and/or other device parts of the overall system.

Preferably, the computer core (CPU) of the connector's computer system executes a computerand/or machine-implemented measurement program for one or more measured values of one or more of these mechanical variables.

For example, the computer core (CPU) of the connector's computer system can calculate derived measured values of mechanical variables, such as real temperature coefficients, from the recorded measured values of these mechanical variables and, if necessary, other available measured values, such as temperature, and thus make them available for monitoring. Material changes, e.g., due to aging, can thus be detected and made accessible for preventive maintenance.

The computer core (CPU) of the connector's computer system and thus the connector's computer system and thus the connector and/or the higher-level control unit and/or one or more computer cores of one or more computer systems of one or more connectors and/or one or more connector connections are thus preferably configured to execute a computer- and/or machine-implemented voltage and/or resistance and/or conductivity measurement program for these mechanical variables of the connector and/or the connection.

This has the advantage that the connector and/or the plug connection or their device parts and/or one or more computer cores of one or more computer systems of one or more other connectors and/or one or more other plug connections and/or or the higher-level control unit and/or one or more other device parts of the overall system can detect critical changes in the mechanical properties of the connector on the one hand and/or the mechanical and/or thermal load on the other hand by performing computer- and/or machine-implemented analysis procedures based on these measured values and by computer- and/or machine-implemented comparison of one or more of the recorded and/or or determined from them with one or more respective permissible measured value ranges and can accordingly take countermeasures and send signals to the users and the said higher-level control unit and/or other computer cores of other computer systems of other connectors and/or plug connections and/or other device parts of the overall system.

This reduces hazards such as failure to detect a mechanical malfunction in the vicinity of the connector and/or impending damage to the connector, etc.

If necessary, the computer core (CPU) of the connector's computer system can report one or more measured values for one or more mechanical variables via the data interface to a higher-level control system and/or the computer core of another computer system of another connector and/or a higher-level control system and/or another device part of the overall system.

It is conceivable that the computer core of the connector's computer system uses an actuator, for example a heater, to apply a mechanical test voltage source of the connector to mechanical stresses in the housing material of the connector housing in order to be able to examine and determine the mechanical properties in a targeted manner using a computer- and/or machine-implemented method. Preferably, the computer core (CPU) of the connector's computer system controls such an actuator via the data bus of the connector's integrated circuit.

The predetermined signal may comprise information relating to an identifier of the connector and/or information relating to the deviation of the actual status of the connector from the predetermined target status.

The identifier can be understood as a label or information. This is suitable for the optional unique identification of the connector.

The output of the identifier offers the advantage that the connector at which the electronic fuse has tripped can be identified. This in turn enables the implementation of a variety of monitoring, analysis, and/or control functions.

The connector may comprise a memory module in which the information relating to the identifier is stored.

The memory module may be a data storage device designed to store the information relating to the identifier in the form of (digital) data. The memory module may be a volatile and/or non-volatile data storage device. The data storage device may comprise a read-only memory (ROM), a programmable read-only memory (PROM), an erasable programmable read-only memory (EPROM), and/or electrically erasable programmable read-only memory (EEPROM, flash, OTP (one-time programmable), ROM, MRAM, FRAM). The data memory may comprise a flash memory.

It is also conceivable to use volatile memory (RAM, SRAM, DRAM), etc. for storing data. Preferably, a small electrical energy storage device in the connector supplies this volatile memory with electrical energy outside the operating phases and, within the operating phases, preferably only when the electrical supply of electrical energy to device parts of the connector is not provided or is not possible.

The target status can be defined at least in part by at least one of the following variables and/or their temporal progression.

For example, this may be at least one target temperature of the connector, at least one target voltage applied to the connector and/or at least one target current flowing through the connector and/or a temperature range of the connector and/or a temperature threshold value of the connector.

In other words, the electronic temperature fuse, which may be located in the connector and/or in another connector of the overall system and/or in the higher-level control unit and/or in another device of the overall system, or may be such another device of the overall system, can trigger when the actual temperature of the connector exceeds and/or falls below a predetermined limit value and/or is outside a predetermined (value) range. It is conceivable that a time component is taken into account, i.e., that the electronic temperature fuse triggers when the actual temperature of the connector exceeds and/or falls below a predetermined limit value for a predetermined period of time and/or is outside a predetermined (value) range for a predetermined period of time. In addition, or alternatively, the electronic fuse can trip if an actual voltage applied to the contact interface of the connector exceeds and/or falls below a predetermined limit value relative to a reference potential and/or is outside a predetermined (value) range. It is conceivable that a time component is taken into account, i.e., that the electronic fuse trips when the actual voltage exceeds and/or falls below a predetermined limit value for a predetermined period of time and/or is outside a predetermined (value) range for a predetermined period of time. In addition, or alternatively, the electronic fuse may trip if the connector comprises a current sensor for the current flowing through one of its contact interfaces and an actual current flowing through such a contact interface of the connector exceeds and/or falls below a predetermined limit value and/or is outside a predetermined (value) range. It is conceivable that a time component is taken into account, i.e., that the electronic fuse trips when the actual current exceeds and/or falls below a predetermined limit value for a predetermined period of time and/or is outside a predetermined (value) range for a predetermined period of time (value) range for a predetermined period of time and/or if the integral of the difference between the square of the electric current multiplied by a predeterminable coefficient on the one hand minus a predeterminable parameter exceeds a predeterminable threshold value. It is conceivable that an interaction between two or more of the aforementioned variables is taken into account, i.e., that the electronic fuse trips, for example, when the actual temperature of the connector, the actual voltage and/or the actual current and/or the actual power each exceed and/or fall below a predetermined limit value and/or are each outside a predetermined (value) range. Here, too, a time component can be taken into account in the manner described above. It is conceivable that the predetermined first signal contains information indicating which of the above variables and/or their temporal progression led to the triggering of the electronic fuse. This also applies to the preceding sections.

Furthermore, the disclosure relates to a communication system, optionally of a vehicle, wherein the communication system has one or more of the electrical connectors described above and a device for data processing, for example in said higher-level control unit and/or in one or more of the computer systems of one or more connectors and/or in another device part of the overall system, which is connected via the communication network by means of the data communication channel to the connector, preferably to the computer system of the connector, and which is designed to receive the predetermined signal from the connector via the communication network.

In the context of this document, the communication system (or communication network, specifically in relation to telecommunications, a telecommunications system or telecommunications network) can be understood as a network for the transmission of messages in a communications network. The network has several participants, in this case at least the electrical connector and the data processing device.

The above explanation with reference to the electrical connector applies analogously to the communication system and vice versa.

The data processing device may comprise or have a further electrical connector or consist of it and/or be part of a plug connection.

The data processing device may comprise or consist of an electronic control unit, for example the aforementioned higher-level control device.

Furthermore, the disclosure preferably relates to a method, implemented in whole or in part by computer and/or machine, for operating an electrical connector as described above, wherein the method comprises detecting at the integrated circuit which electronic fuse has been triggered and outputting the predetermined signal to the communication network connected to the connector.

The above description with reference to the electrical connector and the communication system applies analogously to the method and vice versa.

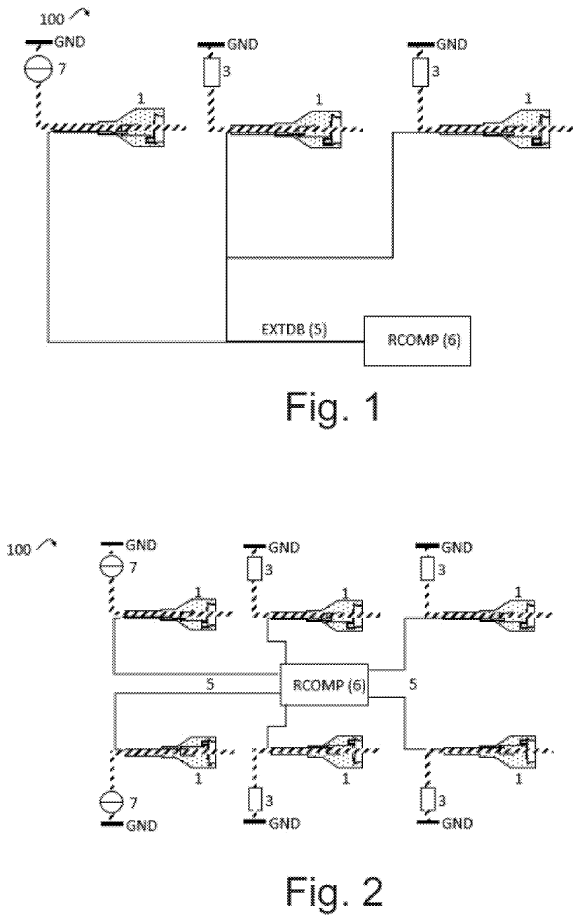

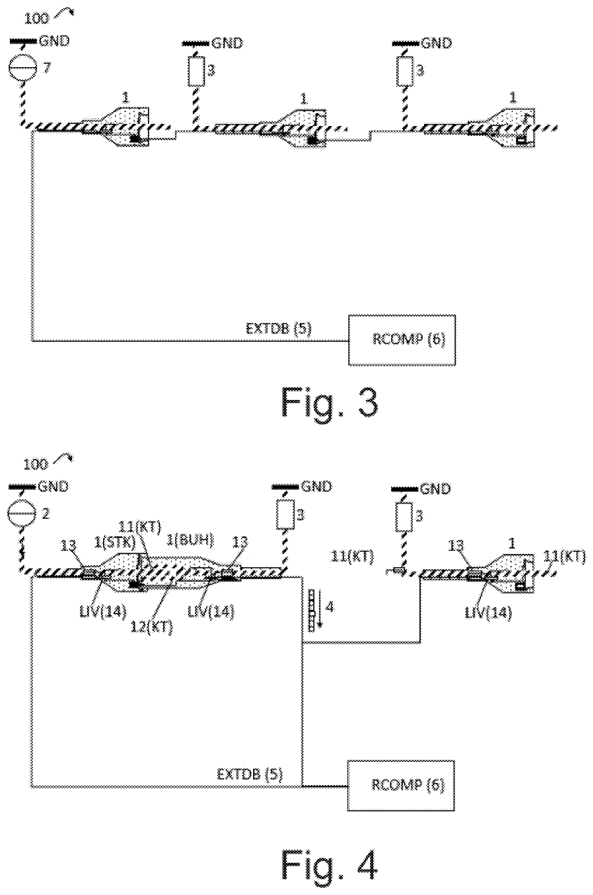

The communication system 100, which is shown only schematically and in part in FIG. 1 and which, for example, can be installed in a vehicle (not shown), has an electrical connector 1 and a data processing device 6, which is connected to the connector 1 via a communication network 5 and is designed to receive a predetermined signal 4 from the connector 1 via the communication network 5. The communication network 5 may comprise electrical lines that enable data transmission from the electrical connector 1 to the data processing device 6. However, it is also conceivable to additionally or alternatively enable wireless data transmission via the communication network 5 from the electrical connector 1 to the data processing device 6. The line LTG of the connector 1 can be connected to a current, voltage, or electrical energy source 7. The line LTG of the connector 1 can be connected to a load or a current sink 3. The connector 1 may comprise, for example, a socket BUH or a plug STK. The data processing device 6 may be a higher-level (optionally electronic) control unit RCOMP, to which more than one of the electrical connectors 1 may optionally be connected in the manner described herein. It is also conceivable that the data processing device 6 is at least partially implemented in or as part of a further electrical connector 1′ (see also FIGS. 2 and 3).

FIG. 2 schematically shows the communication system 100 from FIG. 1 with twice as many connectors 1 when it has a point-to-point topology with point-to-point connections to the data processing device 6. The data processing device 6, which is designed as a higher-level control unit, is located in the center and is connected in parallel to the electrical connector 1 and several other electrical connectors 1, which may have the same configuration as connector 1, via the communication network 5.

FIG. 3 schematically shows the communication system 100 from FIG. 1 when the data bus 5 has a linear series connection topology. This is particularly advantageous for auto-addressing methods for assigning data bus addresses to the computer systems of the connectors 1. The data processing device 6, which is designed as a higher-level control unit, is connected in series with the connector 1 and the several other connectors 1′, which may have the same configuration as the connector 1, whereby the connectors 1, 1′ are each connected to each other and to the data processing device 6 via the communication network 5.

The topologies shown in FIGS. 2 and 3 are only two examples of a variety of topologies in which the disclosed solution can be applied. The following topologies, among others, are conceivable, as well as a combination of two or more of the following topologies (i.e., hybrid): ring, meshed, star, fully meshed, line or point-to-point, tree, and bus.

As can be seen from FIG. 4, the electrical connector 1 (plug STK) of the electrical plug connection has an electronic fuse 13 which is designed to trigger a deviation of an actual status of the connector 1 (plug STK) from a predetermined target status of the electrical connector 1 (plug STK), and an integrated circuit 14 of the electrical connector 1 (plug STK) with a control device LIV, which is designed to output a predetermined signal 4 to the communication network 5 connectable to the plug connector 1 (plug STK) when the electronic fuse 13 of the plug connector 1 (plug STK) triggers or has triggered.

As can be seen from FIG. 4, the electrical connector 1 (socket BUH) of the electrical plug connection has an electronic fuse 13 which is designed to trigger from a predetermined target status in the event of a deviation in the actual status of the connector 1 (socket BUH) from a predetermined target status of the plug connector 1 (socket BUH), and an integrated circuit 14 of the connector 1 (socket BUH) with a control device LIV, which is designed to output a predetermined signal 4 to the communication network 5 connectable to the connector 1 (socket BUH) when the electronic fuse 13 of the connector 1 (socket BUH) triggers or has triggered.

The connector 1 (plug STK) has a first contact interface 11 (KT) for connecting the connector 1 (plug STK) to a power source 2 and a second contact interface 12 (KT) for connecting the connector 1 (socket BUH) to a power sink 3.

The integrated circuit 14 is electrically connected to the first and second contact interfaces 11, 12 and a reference potential, for example an electrically conductive vehicle body, in order to supply it with electrical energy. The direction of current flow from the power source 2 via the connector 1 to the current sink 3 is indicated by the arrow shown in FIG. 4.

The respective integrated circuit 14 is designed to output the respective predetermined signal 4 to the communication network 5 when the respective electronic fuse 13 trips. The tripping may include interrupting the flow of current through the respective electronic fuse 13.

The respective electrical connector 1 has a respective interface to the data interface DBIF, via which the integrated circuit 14 (LIV) is designed to output the predetermined signal 4 wirelessly and/or wired to the communication network 5 and thus to the data processing device 6.

The connector 1 may have a first power supply module which is designed, for example, to convert thermal energy into electrical energy in order to supply the integrated circuit 14 (control device LIV) with electrical energy. The electrical energy can be used to transmit the first predetermined signal 4.

The connector 1 may, for example, comprise a second power supply module designed to use electromagnetic induction to supply the integrated circuit 14 with electrical energy. The electrical energy can be used to transmit the first predetermined signal 4.

The connector 1 has an energy storage device EQ for supplying the integrated circuit 14 with electrical energy. The electrical energy can be used to transmit the first predetermined signal 4. The electrical energy to be stored or stored in the energy storage device EQ can be provided by the first and/or second power supply module and/or via the electrically conductive connection of the integrated circuit to the first and second contact interfaces 11, 12.

The predetermined signal 4 may contain information relating to an identifier of the connector 1 and/or information relating to the deviation of the actual status of the connector 1 from the predetermined target status. This information is received by the data processing device 6. The connector 1 has a memory module and/or a memory MEM in which the information relating to the identifier and/or relating to the deviation of the actual status of the connector 1 from the predetermined target status can be stored. The target status is defined at least in part by at least one of the following variables and/or their temporal progression: at least one target temperature of the connector 1, at least one target voltage applied to the connector 1, and/or at least one target current flowing through the connector 1.

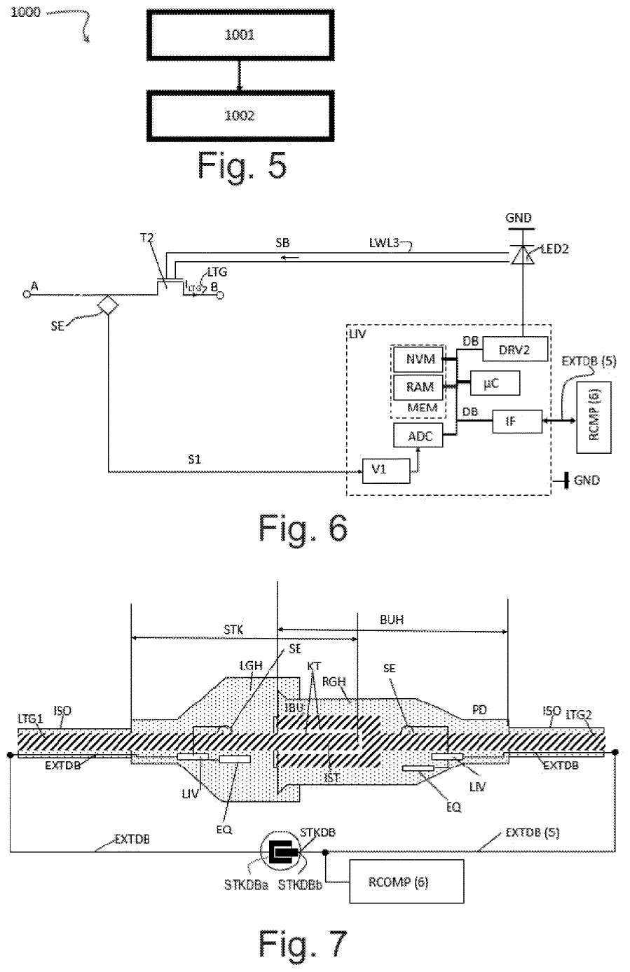

FIG. 5 shows an example flowchart of a method for operating an electrical connector 1 as described above. The method comprises, in a first step 1001, determining at or from the integrated circuit 14 (LIV) that the electronic fuse 13 has tripped, and, in a second step 1002, outputting the predetermined signal 4 to the communication network 5 connected to the connector 1.

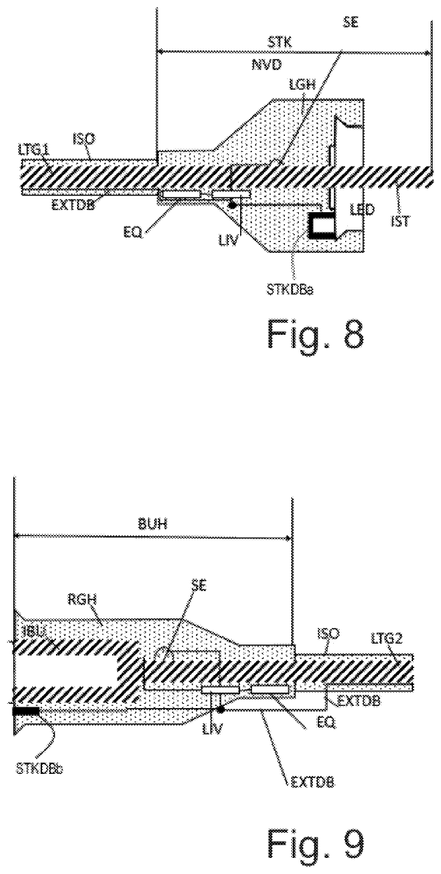

In particular, the document presented here proposes inserting an optically and/or electrically controllable electronic switch T2 into the conductor LTG of a socket BUH, for example as shown in FIG. 9, and/or in particular into the conductor LTG1 of a plug STK, for example as shown in FIG. 8, which can interrupt and/or allow the flow of current through the conductor LTG2 of the socket, for example, as shown in FIG. 9, and/or through the conductor LTG1 of the plug STK, for example, as shown in FIG. 8.

In the example of FIG. 6, this electronic switch T2 is optically controlled, for example. This has the advantage of complete galvanic separation.

Instead of optical control, electrical control of the control contact of the electronic switch T2 by the control circuit LIV via a corresponding line not shown here is conceivable as an alternative to optical control via the optical waveguide LWL3 and the switching LED LED2.

The control circuit LIV in FIG. 6 is exemplarily designed as a processor for a software-defined sensor. For the purposes of this document, the sensor comprises the sensor element SE and the control circuit LIV, which comprises the computer system.

The essential idea of the device shown in FIG. 6 is thus the use of a second switch T2, which is now controlled by the control circuit LIV by means of a galvanically isolating device, shown here as an example, by means of the third optical fiber LWL3 and by means of the switching LED LED2.

This means that no direct electrical connections are required between the electrical line LTG and the second switch T2 on the one hand and the control circuit LIV and the auxiliary means of the control circuit LIV on the other. This means that the electrical line LTG and the second switch T2 on the one hand can be at any electrical potential relative to the control circuit LIV and the auxiliary means of the control circuit LIV on the other hand, which represents a considerable safety advantage. For the purposes of this document, the aforementioned auxiliary devices of the control circuit LIV are device components that are directly connected to the control circuit LIV.

In the example shown in FIG. 6, the control circuit LIV supplies the switching LED LED2 with electrical energy, for example, when the control circuit LIV wants to switch on the second switch T2. The switching LED LED2 then emits light and/or electromagnetic radiation as control radiation SB into the third optical fiber LWL3. The third optical waveguide LWL3 transports this control radiation SB in the form of this light or electromagnetic radiation to the second optically controllable switch T2. Typically, the second optically controllable switch T2 has an optical switching range, for example a PN diode or similar, which switches on the second optically controllable switch T2 when irradiated with this light or electromagnetic radiation in the form of control radiation SB, and switches off the second optically controllable switch T2 when the light or electromagnetic radiation in the form of control radiation SB disappears, i.e., when the irradiation with this light or electromagnetic radiation in the form of control radiation SB ends.

The exemplary control circuit LIV of the software-defined sensor system of FIG. 6 again comprises, for example, the exemplary amplifier V1, the analog-to-digital converter ADC, the computer core μC, the one or more memories MEM, which may comprise volatile memories RAM and non-volatile memories NVM, the data bus interface IF, the internal data bus DB, an optional digital-to-analog converter DAC (not shown) for control via the data bus BDB and for control of actuators or the like, and the first driver stage DRV1. The control circuit LIV of the software-defined sensor system may also comprise other device parts such as input/output interfaces, etc.

In the exemplary device of FIG. 6, the second optically controlled switch T2, here an exemplary second optically controlled power transistor T2, is inserted into the line LTG, as shown in FIG. 6. In the example presented here, the computer core μC of the control circuit LIV preferably controls the second electronic switch T2 by means of a light signal from the control radiation SB of the switching LED LED2. To this end, the computer core μC preferably controls the switching status of the second optically controlled switch T2 by means of the switching LED driver DRV2 and by means of the switching LED LED2, which is temporarily supplied with electrical energy by the latter.

Typically, the switching LED driver DRV2 supplies the switching LED LED2 with electrical energy when the switching LED LED2 switches on the second optically controlled switch T2, since it then emits control radiation SB, which then switches on the optically controlled switch T2.

Typically, the computer core μC of the control circuit LIV causes the switching LED driver DRV2 to supply the switching LED LED2 with electrical energy, for example by means of signaling via one or more signal lines and/or by means of signaling via the data bus DB, when the computer core μC switches on the second optically controlled switch T2 by means of the switching LED LED2, since it then emits control radiation SB, which then switches on the optically controlled switch T2.

Typically, the switching LED driver DRV2 does not supply the switching LED LED2 with electrical energy when the switching LED LED2 switches off the second optically controlled switch T2, since it then no longer emits control radiation SB, which naturally can no longer switch on the optically controlled switch T2.

Typically, the computer core μC of the control circuit LIV causes, for example by means of a signal via one or more signal lines and/or by means of a signal via the data bus DB, the switching LED driver DRV2 to no longer supply the switching LED LED2 with electrical energy when the computer core μC switches off the second optically controlled switch T2 by means of the switching LED LED2.

In a particularly preferred embodiment, the computer core μC of the control circuit LIV controls the second optically controllable switch T2 as a function of the one or more output signals of one or more sensor elements SE. A physical parameter, the line LTG, for example the line temperature ϑ_{LTG} of the line LTG, typically influences the one and/or the several output signals of the one or the several sensor elements SE. The sensor element SE may be, for example, an NTC resistor or a PTC resistor or another temperature sensor element for the purpose of measuring the line temperature ϑ_{LTG}.

The exemplary control circuit LIV of the software-defined sensor system again comprises, for example, the exemplary amplifier V1, the analog-to-digital converter ADC, the computer core μC, the memory MEM, which comprises the volatile memory RAM and the non-volatile memory NVM, the data bus interface IF, the internal data bus DB, the optional, not shown digital-to-analog converter DAC, and the first driver stage DRV1.

In addition, the control circuit LIV of the software-defined sensor system includes a switching LED driver DRV2 for at least temporarily supplying the switching LED LED2 with electrical energy for switching the optically switchable second switch T2. The control circuit LIV of the software-defined sensor system thus additionally comprises this switching LED driver DRV2 for switching on the optically switchable second switch T2. The control circuit LIV of the software-defined sensor system may also comprise other device parts such as input/output interfaces, etc. In the example shown in FIG. 6, the exemplary control circuit LIV of the software-defined sensor system also includes the aforementioned switching LED driver DRV2. The computer core μC of the exemplary control circuit LIV of the software-defined sensor system can activate the optically sensitive switch detector (switching range) of the second optically switchable switch T2 by means of the exemplary switching LED driver DRV2 and thus control the second optically switchable switch T2. This allows the computer core μC of the exemplary control circuit LIV of the software-defined sensor system to activate the optically sensitive switching detector (switching range) of the second optically switchable switch T2 by means of the exemplary switching LED driver DRV2 and to switch the second optically switchable switch T2 on or off depending on the required operating status. As explained above, the second optically switchable switch T2 can typically comprise an optically controlled switch or an optically controlled transistor or optically controlled thyristor or the like.

When the computer core μC switches off the optically controlled second switch T2 by means of the exemplary switching LED driver DRV2 and by means of a disappearance of the light emission of the switching LED LED in the form of the disappearing control radiation SB and by means of a corresponding control via the internal data bus DB, the second optically controlled switch T2 typically interrupts a current flow of a line current I_{LTG} through the line LTG.

When the computer core μC switches on the second, optically controlled switch T2 by means of the exemplary switching LED driver DRV2 and by means of a light emission from the switching LED LED2 in the form of the disappearing control radiation SB and by means of a corresponding control signal via the internal data bus DB, the second optically controlled switch T2 typically allows a line current I_{LTG} through the line LTG.

In the example shown in FIG. 6, the exemplary amplifier V1 of the transmission and evaluation device LIV amplifies and/or filters the output signal of the sensor element SE to produce the amplified and, if necessary, filtered output signal S1.

The analog-to-digital converter ADC of the control circuit LIV samples the amplified and, if necessary, filtered output signal S1 of the sensor element SE, preferably with a sampling period and preferably periodically with a sampling period T_{ADC}.

The analog-to-digital converter ADC of the control circuit LIV can sample the voltage between the second connection B and a reference potential, in this case ground GND, using the analog-to-digital converter ADC and make it available to the computer core μC, for example in a memory MEM of the device.

The analog-to-digital converter ADC of the control circuit LIV can sample the voltage between the first connection A and a reference potential, in this case ground GND, using the analog-to-digital converter ADC and make it available to the computer core μC, for example in a memory MEM of the device. This is not currently shown in FIG. 6 for the sake of clarity. The applicant reserves the right to submit a corresponding drawing in the course of the proceedings or in the event of legal action against a property right from this patent application, showing an electrical connection between the analog-to-digital converter ADC and the first connection A of the device. Furthermore, this would result in the removal of the galvanic isolation and thus have considerable disadvantages. The document presented here therefore advises against this.

The analog-to-digital converter ADC of the control circuit LIV can sample the voltage between the first connection A and the second connection B of the device or between the connections of the second optically controlled switch T2 via the second optically controlled switch T2 by means of the analog-to-digital converter ADC and make it available to the computer core μC, for example in a memory MEM of the device. This is not currently shown in FIG. 6 for the sake of clarity. The applicant reserves the right to submit a corresponding drawing during the examination procedure or in the event of legal action against a property right from this patent application, showing an electrical connection between the analog-to-digital converter ADC and the first connection A and between the analog-to-digital converter ADC and the second connection B of the device. Furthermore, this would result in the removal of the galvanic isolation and thus significant disadvantages. The document presented here therefore advises against this.

Preferably, the analog-to-digital converter ADC comprises an input multiplexer that enables the device to switch back and forth between these lines of the device in time division multiplex and thus, for each measurement, to select, for example, exactly one of the input lines of the analog-to-digital converter ADC for a subsequent measurement by the analog-to-digital converter ADC. Preferably, the microcontroller μC controls the analog-to-digital converter ADC via the data bus DB. The analog-to-digital converter ADC can make the sampled values available to the computer core μCin various ways.

The analog-to-digital converter ADC can cause the computer core μC to read a valid sample value from a register of the analog-to-digital converter ADC via an interrupt line between the analog-to-digital converter ADC and the computer core μC, which is not shown here for clarity. The applicant reserves the right to submit a corresponding drawing during the examination procedure or in the event of legal action against a property right from this patent application, showing an electrical connection in the form of the aforementioned interrupt line between the analog-to-digital converter ADC and the computer core μC.

The computer core μC can query a register of the analog-to-digital converter ADC via the data bus DB at more or less regular intervals to determine whether a valid, not yet queried new sample value is available, via the data bus DB. If such a valid, not yet queried new sample value is available, the microcontroller μC reads a corresponding register of the analog-to-digital converter ADC and the analog-to-digital converter ADC or the microcontroller μC marks this register value as read.

The analog-to-digital converter ADC can, for example, request the internal data bus DB by means of a bus arbitration logic of the device and be guaranteed access to it for a predetermined time, so that bus collisions on the internal data bus DB are excluded for this time. The analog-to-digital converter ADC can then transfer data, in particular one or more sample values and, if necessary, associated information such as the sampled signal and sampling time, directly to one of the memories MEM for this period and thus make it available to the computer core μC.

Typically, the analog-to-digital converter ADC samples the amplified and, if necessary, filtered output signal S1 of the sensor element SE preferably with a sampling period, preferably periodically or essentially periodically with a sampling period TADC.

Preferably, the analog-to-digital converter ADC of the transmission and evaluation device LIV makes the sampled values of the amplified and, if necessary, filtered receiver output signal S1 of the photodetector PD available to the computer core μC of the control circuit LIV via an internal data bus DB of the control circuit LIV as described above. Preferably, the analog-to-digital converter ADC of the control circuit LIV provides the sampled values of the amplified and, if necessary, filtered output signal S1 of the sensor element SE obtained in this way to the computer core μC of the control circuit LIV via an internal data bus DB of the control circuit LIV together with a respective sampling time as described. Preferably, a sampling time is assigned to each sample value. Provided that the analog-to-digital converter ADC always samples the amplified and filtered output signal S1 exactly in accordance with the sampling period T_{ADC}, the transmission of the sampling times can typically be dispensed with, since the sampling times are automatically determined by adding up the sampling period T_{ADC} on the one hand, and on the other hand, in such cases, typically only the correct data sequence is typically important. For example, in some embodiments, the analog-to-digital converter ADC of the control circuit LIV can make the sampled values of the amplified and, if necessary, filtered output signal S1 of the sensor element SE available to the computer core μC of the control circuit LIV via an internal data bus DB of the control circuit LIV by having the analog-to-digital converter ADC stores or saves the sampled values of the amplified and, if necessary, filtered output signal S1 of the sensor element SE obtained in this way via the internal data bus DB as described above in a predetermined memory area of a memory MEM of the control circuit LIV. If necessary, the control circuit LIV can have the aforementioned bus arbitration device so that the analog-to-digital converter ADC does not cause any transmission and bus collisions with other bus participants of the internal data bus DB, such as the computer core μC, when accessing a memory MEM of the transmission and evaluation device LIV. The memory MEM of the control circuit may comprise volatile memory RAM and non-volatile memory NVM. Preferably, the computer core μC can access the data and program code in the memories MEM of the control circuit LIV via the internal data bus DB for reading and, if provided, for writing. Preferably, the computer core μC executes program code located in one or more memories MEM of the control circuit LIV to perform computer-implemented methods for evaluating the detected sample values of the filtered receiver output signal S1 in order to determine one or more measured values and/or a measured value signal and/or a set of measured value data or the like, or to determine logical values for use in other computer-implemented methods. Preferably, the control circuit LIV has a data interface IF with which the computer core μC can communicate via an external data bus EXTDB with a higher-level computer system RCOMP, for example a higher-level control unit.

It is particularly preferred that the computer core μC executes a computer- and/or machine-implemented method for acquiring measured values by means of the analog-to-digital converter ADC.

Preferably, the measured values determined by the computer core μC using the analog-to-digital converter ADC depend on the values and/or the temporal value curve of the amplified and, if necessary, filtered output signal S1 of the sensor element SE.

Preferably, the measured values determined by the computer core μC by means of the analog-to-digital converter ADC depend on the values and/or the temporal value curve of the output signal S1 of the sensor element SE.

It is therefore particularly preferred that the control circuit LIV controls the second optically switchable switch T2 as a function of the output signal S1 of the sensor element SE.

It is therefore particularly preferred that the control circuit LIV controls the second optically switchable switch T2 by means of the switching LED LED and the switching LED driver DRV and via a third optical system, in this case via the third optical fiber LWL3, as a function of the output signal S1 of the sensor element SE.

It is particularly preferred that the control circuit LIV controls the second optically controllable switch T2 depending on the output signal S1 and/or depending on one or more signals derived from the output signal S1 and/or their time-derived values and/or signals and/or measurement signals and/or or phase-shifted measurement signals and/or one or more signals derived from these signals or values.

In particular, the control circuit LIV controls the second optically switchable switch T2 by means of the switching LED LED2 and the switching LED driver DRV2 and via a third optical system, in this case via the third optical fiber LWL3, depending on the amplified and/or filtered output signal S1 and/or depending on one or more signals derived from the amplified and/or filtered output signal S1 and/or their time-derived values and/or signals and/or measurement signals and/or phase-shifted measurement signals and/or one or more signals derived from these signals or values.

Alternatively or in parallel or simultaneously or intermittently, the transmission and if the computer core μC of the control circuit LIV forms a measured value signal m(t) by means of one or more computer- and/or machine-implemented methods, for example from sample values of the analog-to-digital converter ADC, the control circuit LIV controls the second optically switchable switch T2 by means of the switching LED LED2 and the switching LED driver DRV2 and via a third optical system, in this case via the third optical fiber LWL3, and via the internal data bus DB, preferably as a function of the measured value signal m(t) formed by the computer core μC and/or depending on one or more signals derived from this measured value signal m(t), preferably by the computer core μC, and/or depending on one or more signals formed preferably by the computer core μC, which are related to this measured value signal m(t).

Preferably, the program code that the computer core μC executes to carry out the computerand/or machine-implemented methods of the present document is located, at least temporarily, in a memory MEM of the device. Preferably, data that the computer core μC also uses to execute the computer- and/or machine-implemented methods of the document presented here is also stored at least temporarily in a memory MEM of the device presented here.

In a particularly preferred embodiment, the system of FIG. 6 can execute a temperature protection function.

FIG. 7 shows an exemplary cross-section of a hypothetical, exemplary plug connection (BUH, STK) with an exemplary plug STK and an exemplary socket BUH. This plug connection (BUH, STK) is intended to be only one example of various possible configurations of the combinations of features of the plug connection (BUH, STK). The possible configurations result from the requirements of the claims. One or more sensor elements SE enable the quality of the contact interfaces KT of the plug connection (BUH, STK) to be monitored.

The electrically conductive actual plug IST of the plug connection (BUH, STK) and the electrically conductive actual socket IBU of the plug connection (BUH, STK) establish the actual electrical connection between the left conductor LTG1 and the right conductor LTG2. The left conductor LTG1 and the right conductor LTG2 then form the conductor LTG by electrically connecting the electrically conductive actual plug IST and the electrically conductive actual socket IBU.

The mechanical connection of the plug connection (BUH, STK) is established by the left housing LGH of the plug STK of the plug connection (BUH, STK) and the right housing RGH of the socket BUH of the plug connection (BUH, STK). These typically also provide kink protection and strain relief for the respective conductors (LTG, LTG1, LTG2). According to the proposal, the socket BUH of the plug connection (BUH, STK) and/or the plug STK of the plug connection (BUH, STK) are preferably each provided with at least one sensor element SE.

A respective control device LIV preferably detects the respective value curve of the respective output signal S1(t) of the sensor element SE and forms a respective measured value and/or a respective measured value signal from it. Preferably, a respective energy source EQ, which may be a respective battery, a respective charged accumulator, a respective charged capacitor, or a respective energy source connected to the respective device of the respective system by wire or wirelessly, supplies the respective device and, in particular, the respective control device LIV with respective electrical energy at least temporarily. Preferably, the respective control devices LIV communicate via a wireless or wired data transmission channel EXTDB, which may also be different in each case, but is preferably uniform, with one or more higher-level computer systems RCOMP (remote computer), for example a higher-level control device.

Preferably, the one or more sensor elements SE are each in direct thermal contact with the respective electrical conductor (LTG1, LTG2, LTG).

In the example shown in FIG. 7, a data bus connector DBS connects the two external data buses EXTDB to each other. Preferably, the left part of the data bus connector DBS is housed in the left housing LGH. Preferably, the right part of the data bus connector DBS is housed in the right housing RGH. The drawing here shows the data bus connector DBS separately for illustrative purposes only.

FIG. 8 shows the exemplary connector STK of FIG. 7 separately as part of a left cable section.

FIG. 9 shows the exemplary socket BUH of FIG. 7 separately as part of a right cable section.

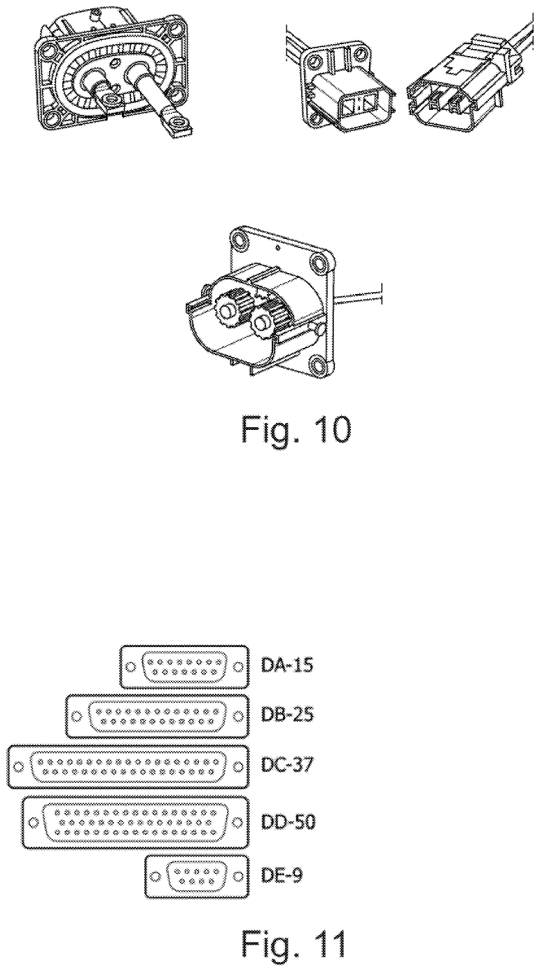

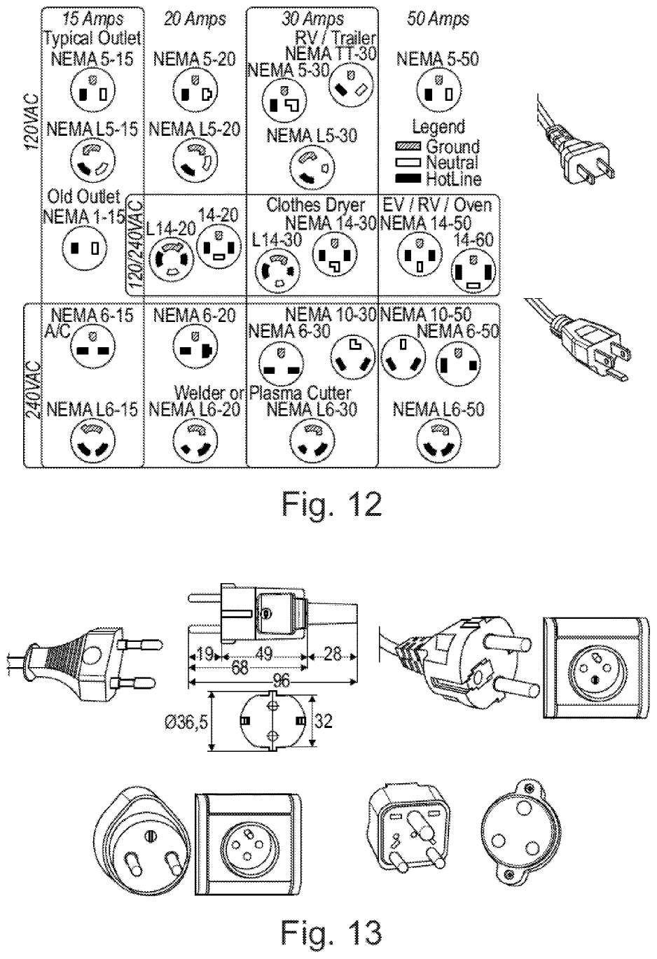

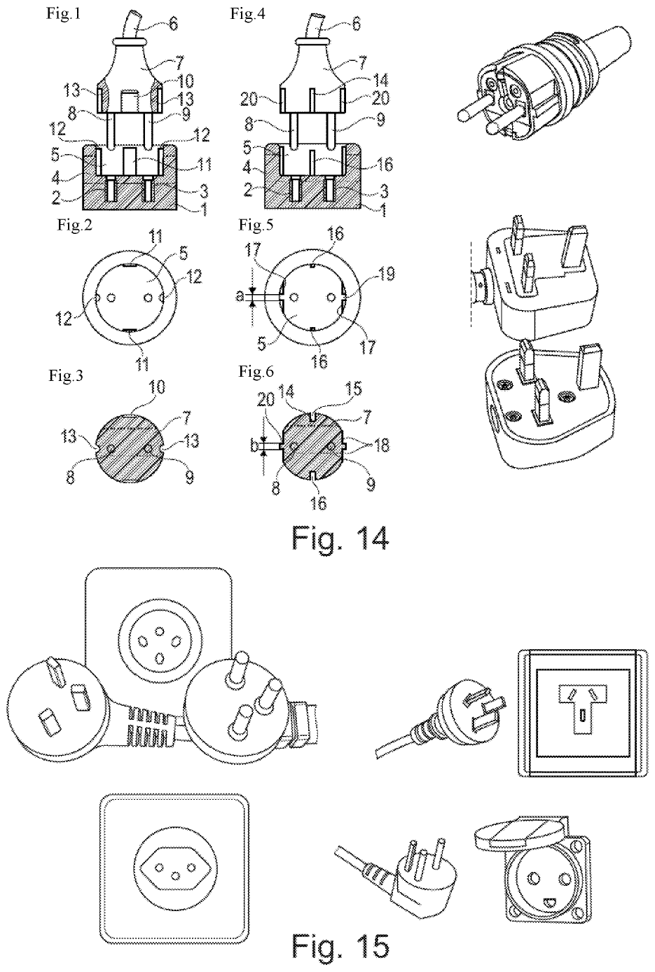

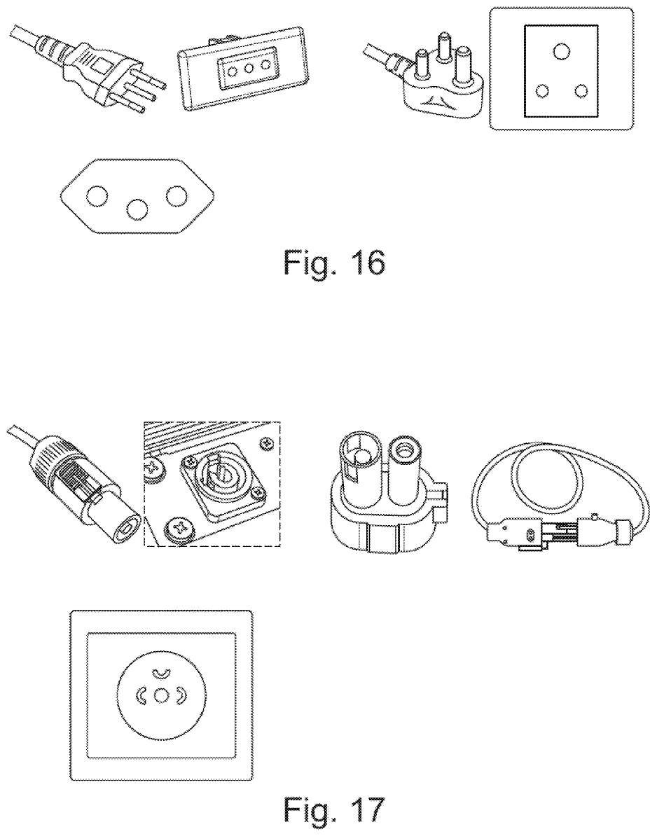

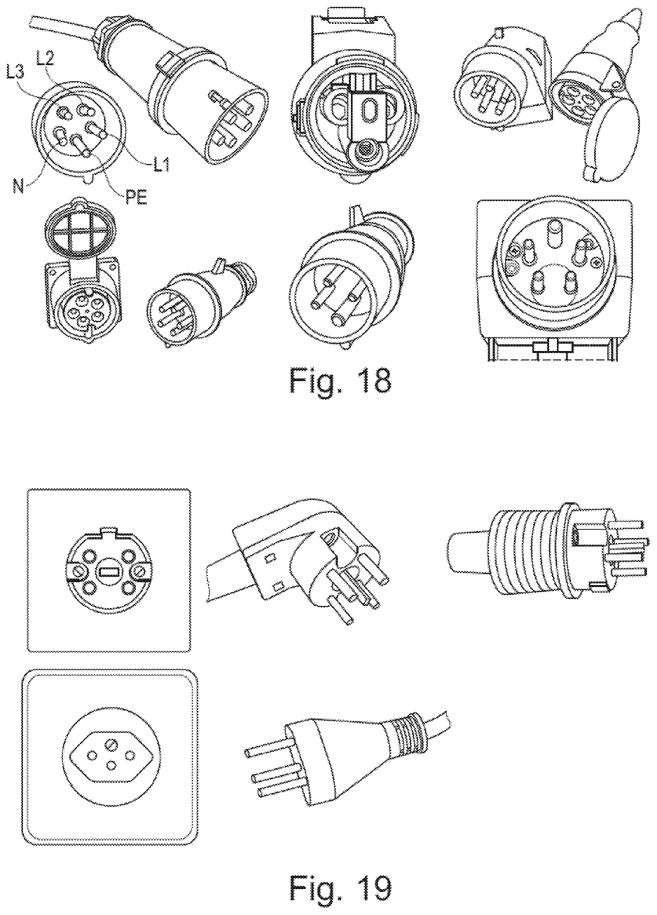

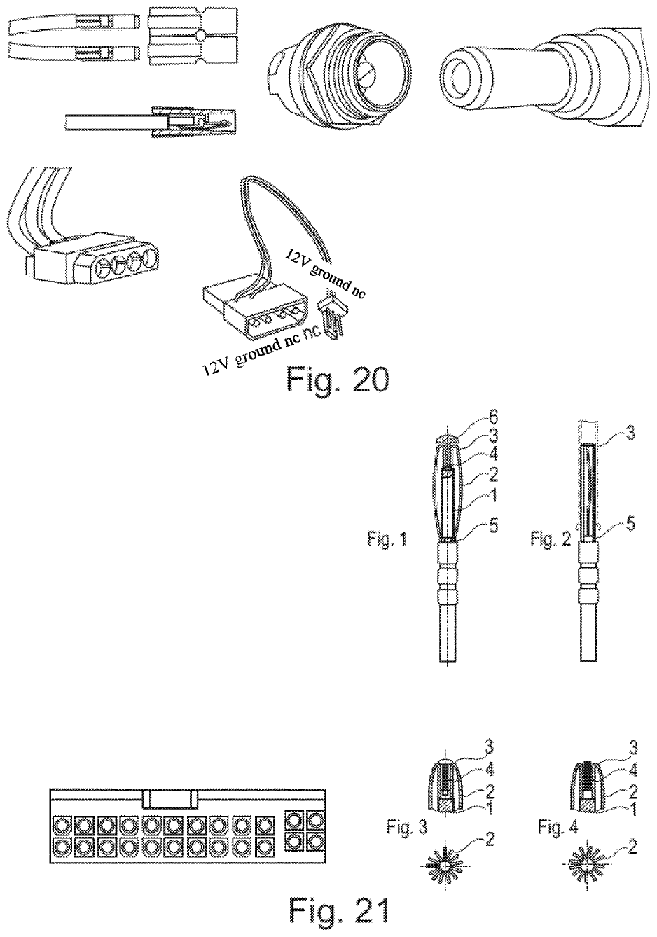

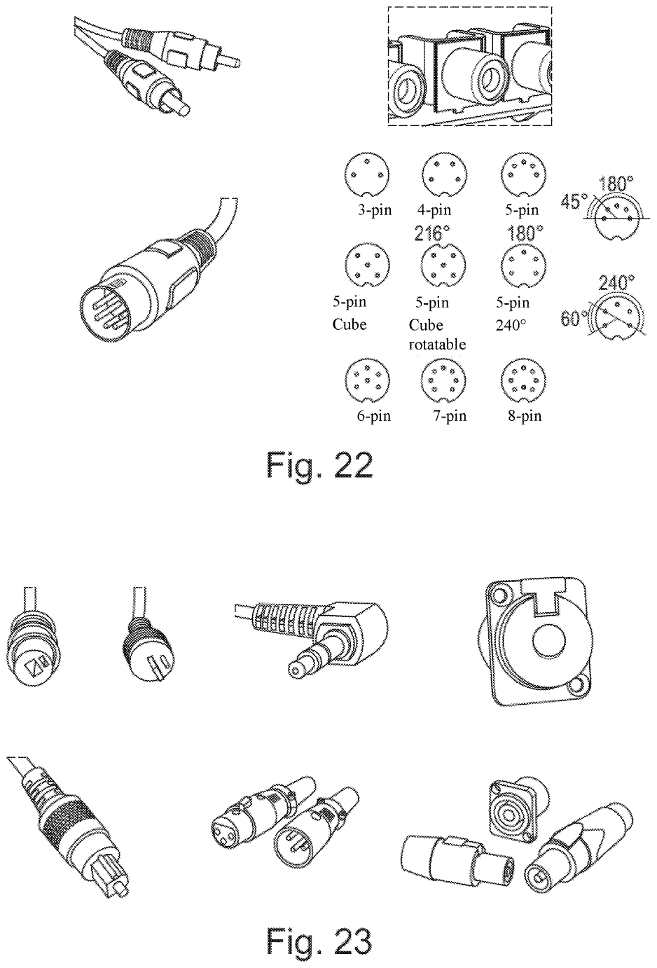

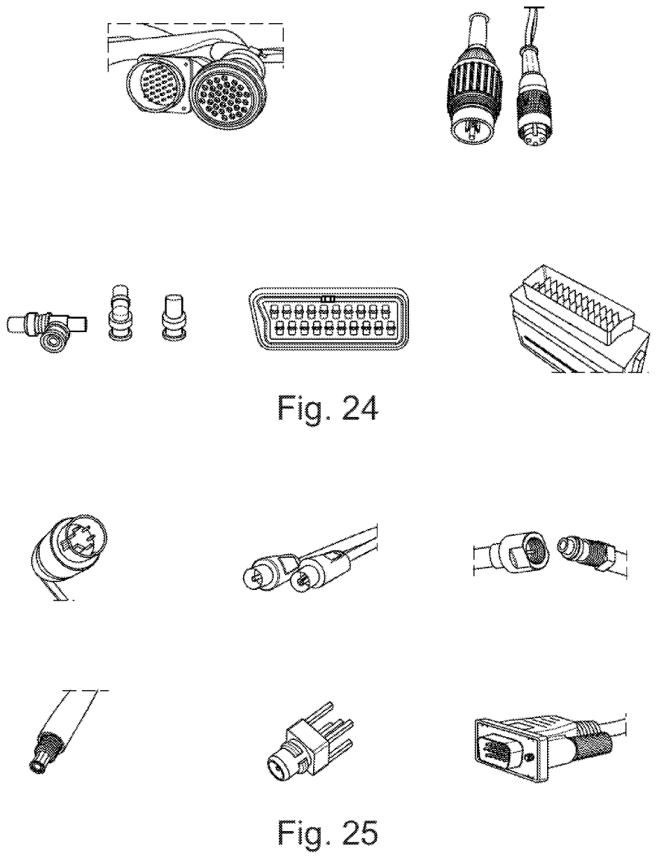

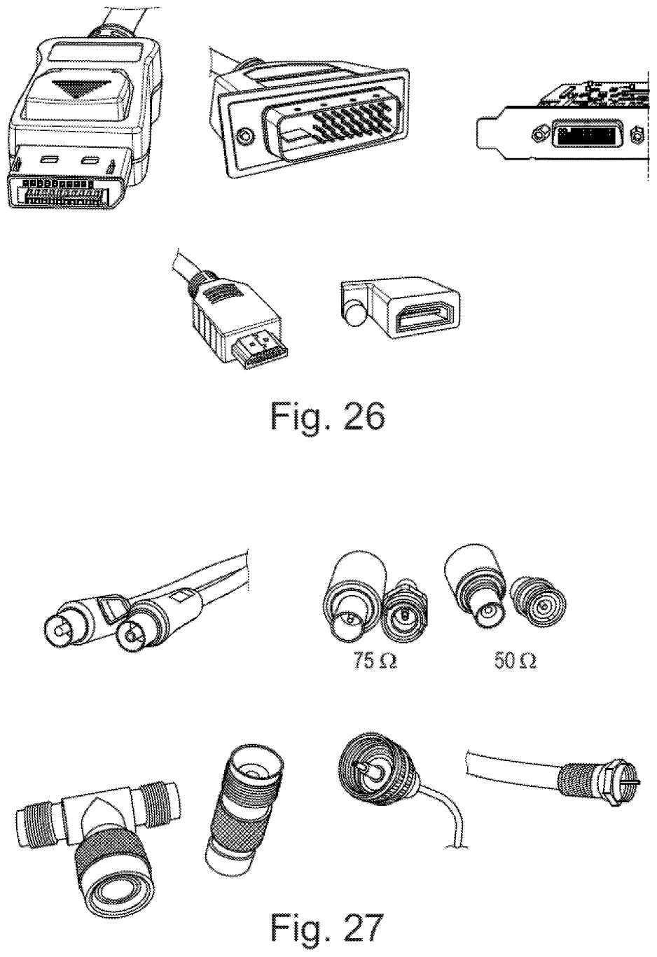

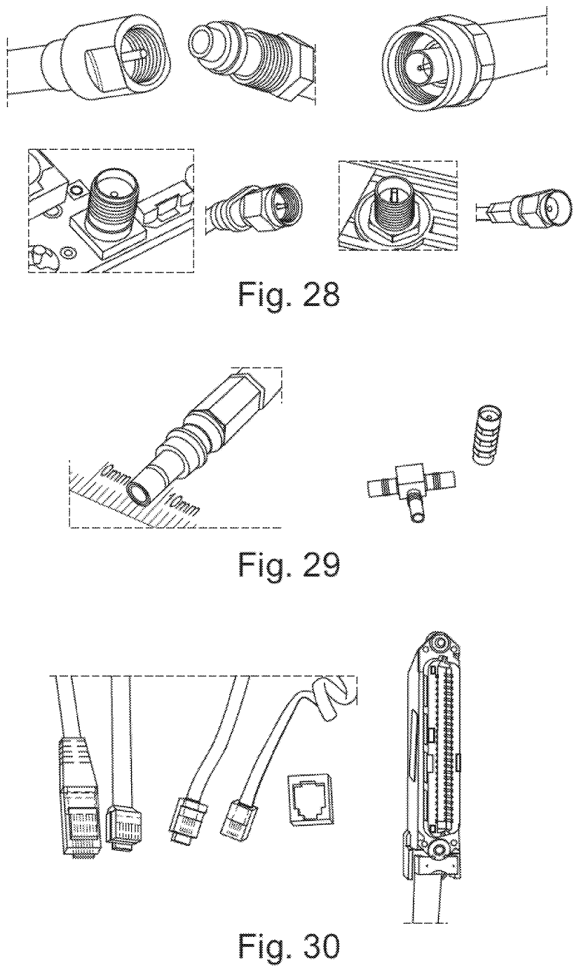

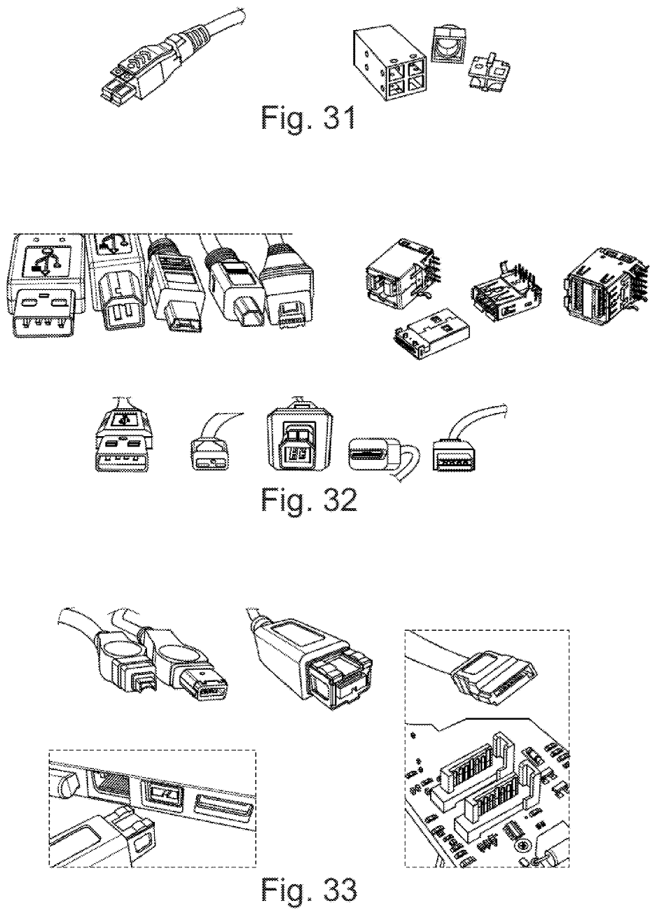

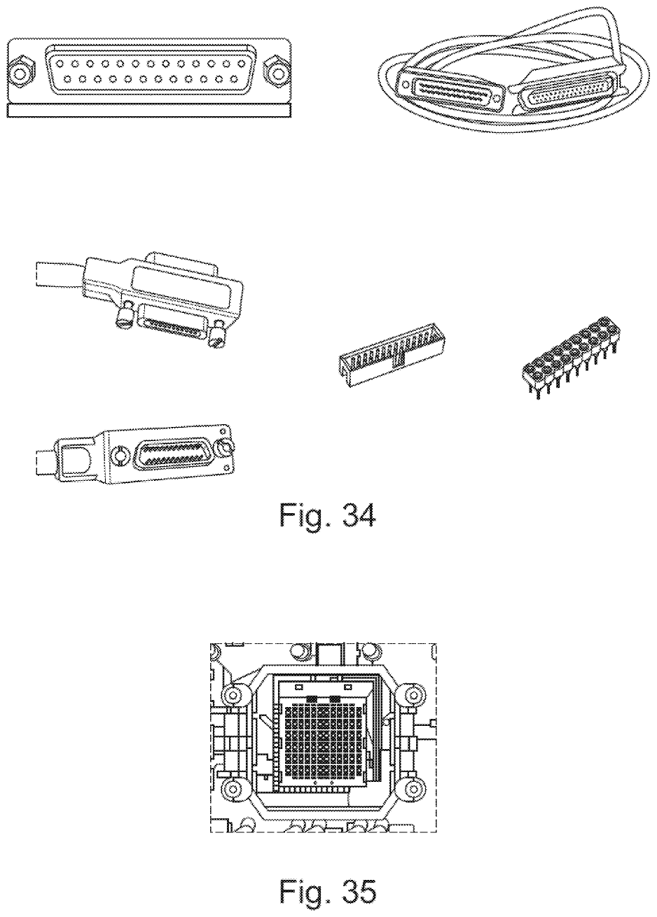

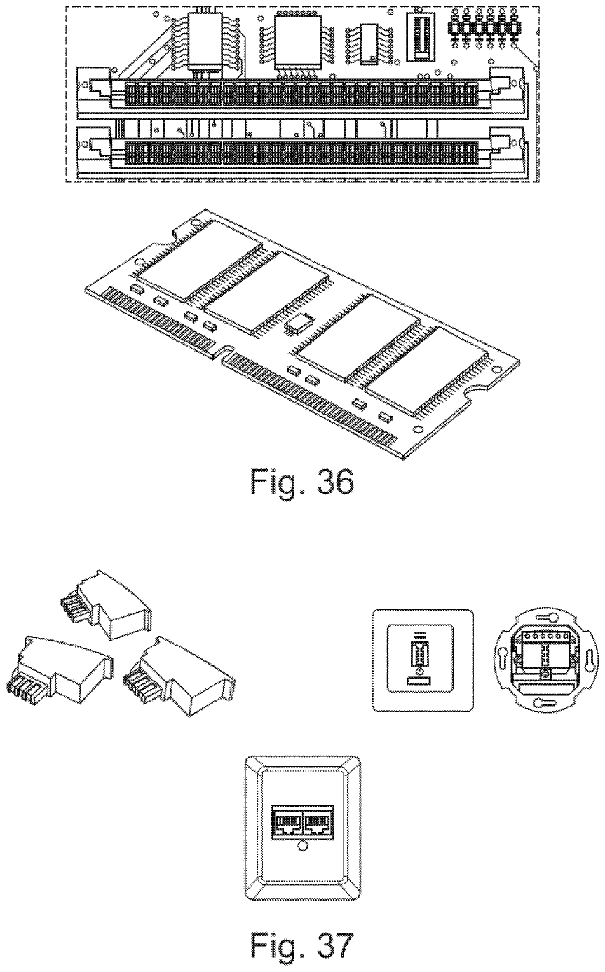

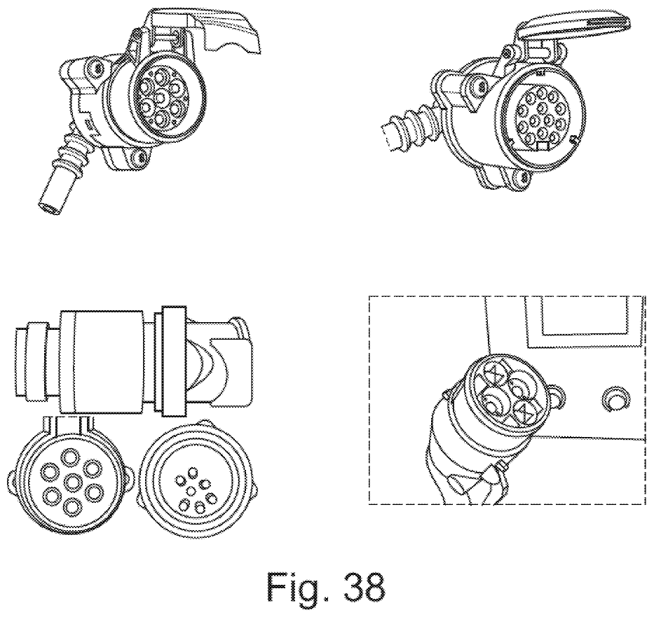

FIGS. 10 to 38 show images of various plug variants of the plug types listed in the glossary below.

The following exemplary and incomplete list of connectors and connector systems is only provided as an example in this document. The technical teaching of the document presented here is expressly not limited to these examples.

### Power Plug

D-Sub plug IEC 807-2.[1] Depending on the application and country, this connector system is specified in various additional standards due to its widespread use, such as the US military standard MIL-C-24308 or, in Germany, the DIN standard 41652-1.[2][3] Within the framework of ISO standards, individual variants such as ISO 4903 for DA-15 and ISO 2110 for DB-25
American 2-pin connector system (Type A)
American 3-pin plug system (Type B) NEMA-1, NEMA-5, NEMA-6,
Euro flat plug (Type C, EN 50075)
Indian/old British plug system (Type D)
French plug system (Type E)
German-French combination plug (Type EF, CEE 7/7)
European contour plug (type EF, CEE 7/17)
German Schuko plug system (type F, CEE 7/4) (see also DE567906C)
Russian plug system (type F, GOST 7396)
British plug system (type G, BS 1363)
Israeli plug system (type H)
Australian plug system (Type I)
Australia: applicable standard: AS/NZS 3112
New Zealand: relevant standard: AS/NZS 3112
Papua New Guinea: relevant standard: AS/NZS 3112
China (partially): relevant standard: GB 1002
Argentina: relevant standard: IRAM 2073
Uruguay: applicable standard: IRAM 2073
Swiss plug system (Type J, SN 441011)
Danish plug system (type K)
Italian plug system (type L)
South African plug system (type M)
IEC 60906-1 international standard plug
Brazilian plug NBR 14136, very similar to IEC 60906-1, but not identical
PowerCon, (frequently used in stage technology, proprietary)
Plug according to DIN 56905, (used almost exclusively in stage technology, predecessor of PowerCon
Terko for direct or alternating current, reverse polarity protection (proprietary)

### Single-Phase and Multi-Phase Low-Voltage Systems

Plug connection with Anderson Powerpole connectors
Plugs according to IEC 60309 (such as the 5-pin CEE three-phase connectors for 16 to 125 amps)
In Germany, Austria, the Netherlands, and Sweden: Perilex for three-phase current according to DIN 49445 (16 A socket) and DIN 49446 (16 A plug), DIN 49447 (25 A socket) and DIN 49448 (25 A plug)
In Switzerland: Three-phase connectors for low currents for domestic, commercial, and industrial use in accordance with SN 441011, (T15 for 10 A and T 25 for 16 A). Corresponding sockets can also accept single-phase plugs; historically, J plugs are also used.
Anderson Powerpole, (system with hermaphroditic plugs up to 600 volts and 310 amps)

### Low-Voltage Plugs

Low-voltage plugs are used to supply low, non-hazardous voltages (“functional low voltage”). However, they sometimes operate with very high currents (ATX plugs up to 120 A).

### Barrel Connectors for Small Devices

Molex connectors, rectangular four-pin connectors in computers for supplying power to hard drives, CD/DVD drives, etc.
Connectors from PC power supplies to the motherboard, e.g., according to the ATX standard
Wire spring contacts (wire spring sockets are more common today) (e.g., DE923143C)
On-board power outlet (cigarette lighter)
MagSafe, magnetic connectors for Apple notebooks
Audio plug
RCA: separate for right and left unbalanced stereo signals
DIN connectors, also known as diode connectors, are available in mono and stereo versions, are outdated, and are also used for other purposes
Pickup plugs for old tube radios
Speaker plugs and measuring device plugs, two very similar connectors that are also obsolete
Jack plugs are two-pole for mono signals, three-pole for stereo signals, and four-pole for headsets; plugs with more than four poles are prone to deformation due to their design and are very rare, often being replaced by several individual plug connections and, if necessary, bundled with D-sub plug adapters
TOSLINK, optical connector
XLR in recording studios and on stage
Speakon speaker connectors
Multipin for mixing consoles and stage boxes
Small and large Tuchel, older microphone connectors
D-Sub connectors: (In the PC sector, the connectors are often connected to professional sound cards using device-specific adapters (cable whips) to enable the connection of standard connectors (e.g., RCA, DIN, jack, XLR) that otherwise could not be connected due to space constraints.
BNC plugs and couplings
TriAx plugs and couplings
SCART
RCA plugs
Mini-DIN (also known as S-Video or Hosiden, SCART)
Belling-Lee plugs (better known as antenna cables)
F connectors in satellite systems for transmitting the satellite intermediate frequency between the dish and the receiver
In computer technology:
SMA plugs and SMA sockets
VGA connector plug
DisplayPort (standard interface in macOS environments)
DVI connectors (Digital Visual Interface)
DMS-59
HDMI plug (currently the most widely used plug in private and semi-professional video applications)
HD-SDI (professional applications)
Serial Digital Interface (professional applications)
Unified Display Interface (obsolete) High-frequency connector
Coaxial plug
N connectors
BNC connectors
TriAx connector
TNC connectors
Belling-Lee connectors
UHF connectors
C connectors
F connectors
FME connectors
SMBA (FAKRA) connectors
MCX, MMCX, and SSMCX connectors
UHF or PL connectors
N connectors
SMA connectors
RP-SMA
SMB connectors
SMC connectors
SMP connectors
SMS connectors
TNC connectors
MCX connectors
MMCX connectors
RP-TNC connectors
UHF connectors (including PL259; originally developed for televisions, but then used exclusively for radio)
DIN-7/16 connectors
RJ connectors
RJ-45 or Ethernet plug
TERA connector system
ELine 1200 EC7
BNC and N connectors for coaxial and twin axial cabling
IBM connector, used in the IBM Cabling System cabling system
USB connector (USB)
FireWire connectors
SATA connectors
SAS connectors
Centronics connector
D-Sub plug
PS/2 plug
Five-pin DIN connectors for MIDI data transfer
IEC bus plug
Pin headers or pin connectors
Chip sockets
Connectors according to DIN 41612 (“VG strip,” various designs, e.g., 96-pin; used, for example, in VMEbus)
Connectors according to DIN 41617 (various designs, e.g., 31-pin)
PCB connectors (used, for example, in plug-in cards in the field of computer technology)
Pin headers, post connectors (used, for example, for extensions of the Raspberry Pi or the Arduino platform)
Sockets for single inline memory modules (SIMM)
Plug-in systems for PCMCIA cards or PC cards
Telephone plugs and sockets (analog)
Travel adapters
Telecommunications connection unit (TAE for short)
ISDN plugs
Universal plug (RJ/Western plug)
Fiber optic connector
SC plug
ST plug
FDDI MIC
LC plug
E2000 plug
FC/PC
FSMA
MTRJ connector
ESCON connector
Mini-BNC
Mini SC
URM P2 connector
TOSLINK (audio data)
M12-FO (IEC 61754-27) Automotive
Trailer sockets
On-board power socket (cigarette lighter)
Charging plug
ISO 10487 (DIN 41652)—Car radio plug: This standard defines connectors for car radios and car radio accessories. Connectors of this type typically have 8 or 10 pins and are used to connect car radios to speakers, antennas, and other accessories.
ISO 10487 (DIN 41652)—ISO plug for car radios: This connector, often referred to as an ISO plug, is a standardized plug type for car radios and devices. It typically has 8 pins and is used to connect car radios to the vehicle's wiring.
ISO 7638—Trailer connector plug: This standard defines connectors for connecting trailers to towing vehicles. It covers connectors for the electrical connection of lights, brakes, and other trailer functions to the towing vehicle.
ISO 11446—Trailer junction box: This is another standard for connectors used in trailers. It defines the junction box that makes the electrical connections between the trailer and the towing vehicle.
J1708/J1587—Connectors for heavy-duty vehicles: This standard defines connectors for connecting electronic control units in heavy-duty vehicles such as trucks and buses. They are used for the diagnosis, monitoring, and control of various vehicle systems.
J1939—CAN bus connectors: This standard defines connectors for the Controller Area Network (CAN) bus, which is used in heavy-duty vehicles, agricultural machinery, and construction machinery for communication between various control units.
SAE J1962—OBD-II connectors: This is a standardized connector type for on-board diagnostics (OBD-II) in motor vehicles. It is used to read diagnostic data from vehicles and read error codes.
SAE J1772—Connectors for electric vehicles: This standard defines connectors for

electric vehicles that are used to charge the batteries. The J1772 connector is widely used worldwide and enables electric vehicles to be charged at charging stations.

### REFERENCE LIST

1 electrical connector
11 first contact interface
12 second contact interface
13 electronic fuse
14 integrated circuit
141 first power supply module
142 second power supply module
143 energy storage
144 storage module
145 data output interface
1′ additional electrical connector
2 current source
3 current sink
4 predetermined signal
5 communication network
6 data processing device
100 communication system
1000 Method for operating an electrical connector
1001 Detecting the tripping of the electronic fuse
1002 Outputting the predetermined signal

What is claimed is:

1. An electrical connector, comprising:
an electrical contact interface for establishing an electrical contact with another electrical contact interface of another connector,
an electrical conductor terminating in the electrical contact interface, and
a contact status sensor, wherein the contact status sensor includes a sensor element that can be arranged and is designed to detect a measured value of a predetermined physical parameter of at least one of the conductor and the contact interface, and a data processing device that is designed to determine an actual status of the electrical contact based on the detected measured value.

2. The electrical connector according to claim 1, wherein the contact status sensor is configured to perform at least one of following tasks: output, store, keep available and use the measured value detected by the sensor element.

3. The electrical connector according to claim 1,
wherein the physical parameter includes a temperature of the conductor, the sensor element comprises a temperature sensor element that can be thermally coupled to the conductor for detecting the temperature of the conductor, and the data processing device is configured to determine the actual status based on the detected temperature of the conductor, and/or
wherein the physical parameter includes a temperature of the contact interface, the sensor element comprises a temperature sensor element that is thermally couplable to the contact interface for detecting the temperature of the contact interface, and the data processing device is designed to determine the actual status based on the detected temperature of the contact interface.

4. The electrical connector according to claim 1, wherein the data processing device is designed to determine an actual status of the conductor and/or the contact interface based on the detected measured value.

5. The electrical connector according to claim 1, wherein the actual status of the contact comprises a failure and/or damage probability of the electrical connector, optionally of the contact interface and/or the conductor.

6. The electrical connector according to claim 1, comprising:
a contact status fuse, and
a switch that can be inserted into the conductor,
wherein the contact status fuse is designed to open and/or close the switch depending on the actual status of the contact.

7. The electrical connector according to claim 1, wherein the electrical connector comprises a socket and/or a plug with the contact interface.

8. The electrical connector according to claim 1, wherein the data processing device includes an integrated circuit designed to output a predetermined signal to a communication network connectable to the connector depending on the actual status of the contact.

9. The electrical connector according to claim 8, wherein the integrated circuit is designed to output the predetermined signal via the contact.

10. The electrical connector according to claim 8, wherein the electrical connector includes a data output interface via which the integrated circuit is designed to output the predetermined signal wirelessly and/or via a wired connection to the communication network.

11. The electrical connector according to claim 8, wherein the connector comprises at least one of following:
a first power supply module designed to convert thermal energy into electrical energy to supply the integrated circuit with electrical energy,
a second power supply module designed to use electromagnetic induction to supply the integrated circuit with electrical energy, and
an energy storage device for supplying the integrated circuit with electrical energy.

12. The electrical connector according to claim 8, wherein the predetermined signal includes information relating to an identifier of the connector and/or information relating to the actual status of the contact, optionally relating to a deviation of the actual status of the contact from a predetermined target status.

13. The electrical connector according to claim 12, wherein the connector includes a memory module in which the information relating to the identifier is stored.
